(19) United States
(12) Patent Application Publication
(10) Pub. No.: US 2019/0389598 A1
(43) Pub. Date: Dec. 26, 2019

(54) SYSTEMS, DEVICES, AND METHODS RELATED TO AIRCRAFT CABIN MODULE STRUCTURES AND TRANSPORT

(71) Applicant: A^3 BY AIRBUS LLC, Sunnyvale, CA (US)

(72) Inventors: Jason Lim Chua, San Jose, CA (US); Martin Sieben, Sunnyvale, CA (US); Angelica Cardona, Boston, MA (US); Guy M. Danner, Somerville, MA (US); Joseph Fenton, Uxbridge, MA (US); Demetrious Harrington, Dartmouth, MA (US); Shahriar Khushrushahi, Cambridge, MA (US); Elena Koukina, Newton, MA (US); Seth Newburg, Arlington, MA (US); Ira Spool, Brookline, MA (US); Hugo Jamson, London (GB); Luke Miles, London (GB); Justin Almeleh, Gardena, CA (US); Alex Herpy, Gardena, CA (US); Matt O'Brien, Gardena, CA (US); Zachary Omohundro, Gardena, CA (US); Edward Smith, Gardena, CA (US)

(21) Appl. No.: 16/560,644

(22) Filed: Sep. 4, 2019

Related U.S. Application Data
(63) Continuation of application No. PCT/US18/22480, filed on Mar. 14, 2018.
(60) Provisional application No. 62/472,509, filed on Mar. 16, 2017.

(51) Int. Cl. B64F 5/50; B64D 11/00; B64C 1/34

(52) U.S. Cl. CPC B64F 5/50; B64D 11/00; B64D 11/02; B64D 2011/0046; B64C 1/34

(57) ABSTRACT

Embodiments of systems, devices, and methods are described that relate to module structures for use in forming a cabin interior of an aircraft. Many embodiments relate to a support structure including a lattice configurable to provide a standardizable frame for connection to the interior of the aircraft and to provide a space within the frame in which module fixtures can be positioned and secured to the frame. Embodiments of the support structure can include a floor with a number of structures and devices that can be used to provide support for the module and secure the module to the floor of the aircraft fuselage. Embodiments of transport systems for the modules are also described and such can be integrated with the floor of the module such that the modules transport mechanism, or a significant portion thereof, is contained within the module itself.

### CROSS-REFERENCE TO RELATED APPLICATIONS

The present application is a continuation of International Patent Application No. PCT/US2018/022480, filed Mar. 14, 2018, which claims priority to and the benefit of U.S. Provisional Patent Application Ser. No. 62/472,509, filed Mar. 16, 2017, both of which are incorporated by reference herein in their entireties for all purposes.

### FIELD

The subject matter described herein pertains to systems, devices, and methods related to cabin module structures and the transport of those cabin module structures.

### BACKGROUND

Passenger aircraft traditionally have a relatively fixed cabin design and infrastructure. From early aircraft with rows of wicker chairs to modern interiors where the chairs and seats include features such as entertainment consoles and wicker seats, interior aircraft design has largely focused on providing an appropriate number of seats and configuration within a particular aircraft platform, along with necessary features such as bathrooms and storage for cabin service items. Although some large aircraft can include additional features such as lay flat seats, private cabins, and lounge areas, aircraft cabins generally include a limited number of seating and non-seating options.

Traditional aircraft cabins also suffer from a lack of flexibility for cabin configurations. Implementing an interior design is very expensive and semi-permanent. Aircraft interiors typically have a 10+year lifespan. If customer demand changes or new features become available, an interior quickly becomes obsolete or undesirable. Because it is extremely expensive to upgrade or update the cabin, these undesirable interiors can persist within a fleet for years. Moreover, as a result of the expense and difficulty in updating interiors, an industry can trend towards risk-averse interior designs with known return on investment, and may be missing out on opportunities to significantly improve customer experiences and carrier profitability. Thus, an entire industry of carriers can trend towards similar designs that vary little from early designs.

A carrier can end up with a fleet that has a variety of different cabin configurations based on different specific cabin designs that were prevalent when particular aircraft were purchased or updated. As a result, different planes can provide differing levels of customer experience. Some carriers may assign certain aircraft to a particular subset of routes based on factors such as customer demand for different amenities such as first class seats, entertainment, or other premium services. Short term changes in demand for certain services (e.g., as a result of large events, etc.) may require careful rebalancing throughout an entire fleet, as access to certain services may be limited. In some instances, carriers may lose significant revenue based on the available aircraft at an airport location not matching the types of seating and services that are desired by customers on a particular day.

Because of the limited number of configurations that are actually used in aircraft and regulatory requirements for the certification of aircraft interiors, a limited number of specialized interior suppliers may design and supply a large percentage of interiors for passenger aircraft. The current supply chain and regulatory framework may require large capital expenditures that effectively limit the ability of existing and new interior suppliers to create innovative interiors that may suit specialized customer needs.

### SUMMARY

A number of example embodiments of systems, devices, and methods are described herein that relate to module structures for use in forming a cabin interior of an aircraft. Many of these embodiments relate to a support structure including a lattice that can be configured in numerous ways to provide a standardizable frame for connection to the interior of the aircraft and that also defines a space within the frame in which module fixtures can be positioned and secured to the frame. Embodiments of the support structure can include a floor that includes or is coupled with a number of structures and devices that can be used to provide support for the module and secure the module to the floor of the aircraft fuselage. Embodiments of transport systems for the modules are also described and these transport systems can be integrated with the floor of the module such that the modules transport mechanism, or a significant portion thereof, is contained within the module itself. Certain examples of these transport systems can utilize highflow rate exhaust to enable transport.

Other systems, devices, methods, features and advantages of the subject matter described herein will be or will become apparent to one with skill in the art upon examination of the following figures and detailed description. It is intended that all such additional systems, methods, features and advantages be included within this description, be within the scope of the subject matter described herein, and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1A depicts an example embodiment of an aircraft with a modular cabin and modules distributed therein.

FIG. 1B is a top down view and FIG. 1C is a side view, respectively, depicting example embodiments of the aircraft.

FIG. 1D is a perspective view of a portion of an example embodiment of the aircraft during module loading.

FIG. 1E is a cross-sectional view depicting an example embodiment of an aircraft with a modular cabin.

FIG. 1F is a perspective view depicting an example embodiment of module locations within an interior space defined by an aircraft.

FIGS. 1G-H are perspective views depicting example embodiments of support frames.

FIG. 2 is a conceptual diagram depicting example embodiments of modules.

FIG. 3 is a side view of a portion of a lattice structure in accordance to some embodiments of the disclosure.

FIGS. 4A-4B are perspective views depicting example embodiments of cabin module frames.

FIGS. 5A-5B are cross-sectional views of example embodiments of cross-sections of support frame elements.

FIGS. 6-9 are perspective views depicting example embodiments of support frames.

FIGS. 10, 11A, and 11B are side views depicting example embodiments of lattice structures.

FIGS. 12A and 12B are perspective views depicting example embodiments of hub-less lattice structures.

FIG. 13 is a perspective view of an example embodiment of a cabin module frame with fixtures attached therein.

FIG. 14 is a top view depicting an example embodiment of a hub of a lattice structure.

FIG. 15 is a perspective view of an example embodiment of a cabin module frame being affixed to a portion of fuselage portion.

FIGS. 16A and 16B are top views depicting an example embodiment of a module floor.

FIGS. 17A-D are perspective views depicting example embodiments of an attachment bracket assembly.

FIG. 17E is a top view depicting example attachment locations on the main floor of a fuselage.

FIG. 18A-C are perspective views depicting example embodiments of an eccentric gear attachment system.

FIG. 19 is a perspective view depicting an example embodiment of a locking shaft.

FIG. 20 is a top view depicting an example embodiment of a mounting bracket.

FIG. 21 is a perspective view depicting an example embodiment of an outer eccentric gear.

FIGS. 22A-22B are views depicting example embodiments of an inner eccentric gear.

FIG. 23 is a side view depicting an example embodiment of a module floor with an integrated module lifter system.

FIG. 24A-C are perspective views depicting example embodiments of a module lifter.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

### Overview

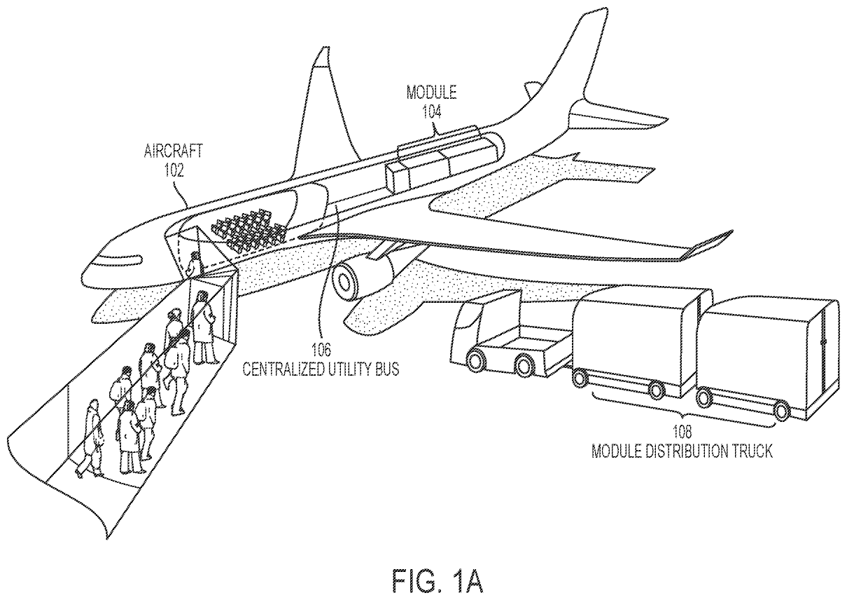

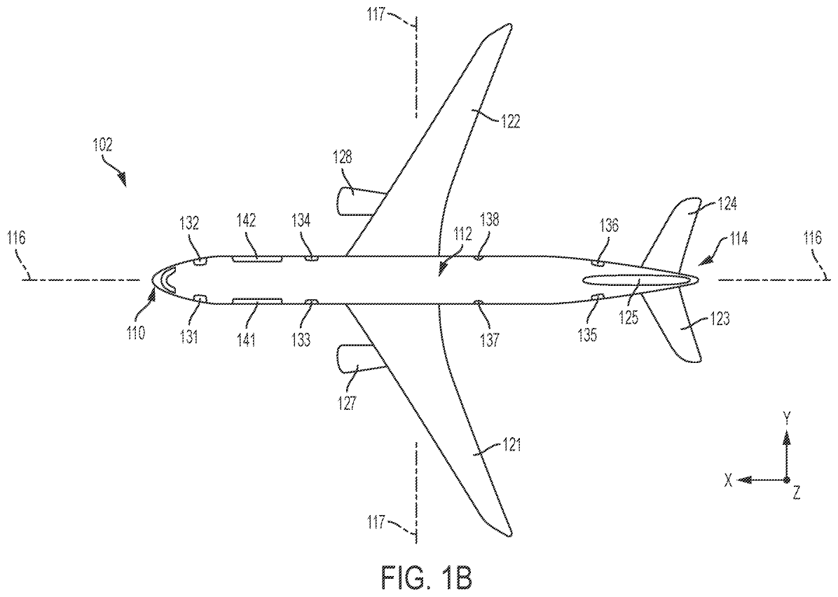

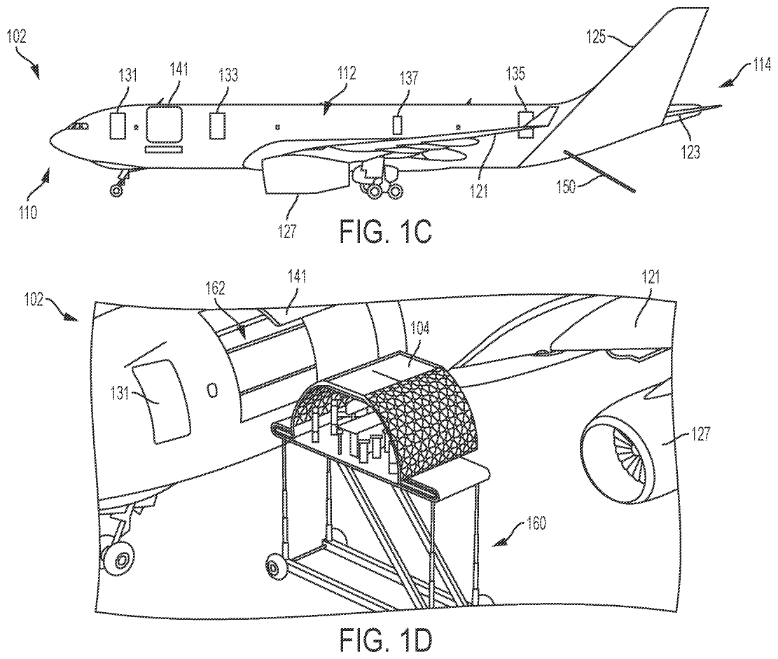

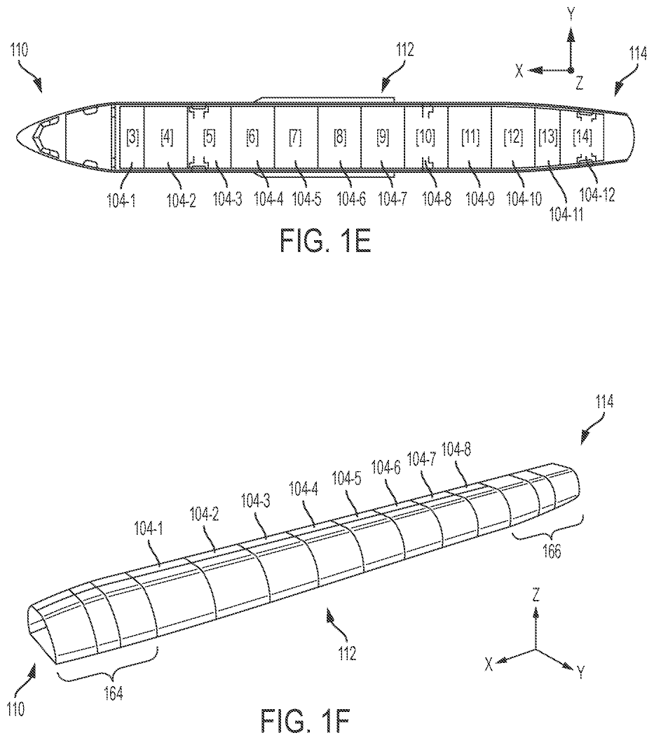

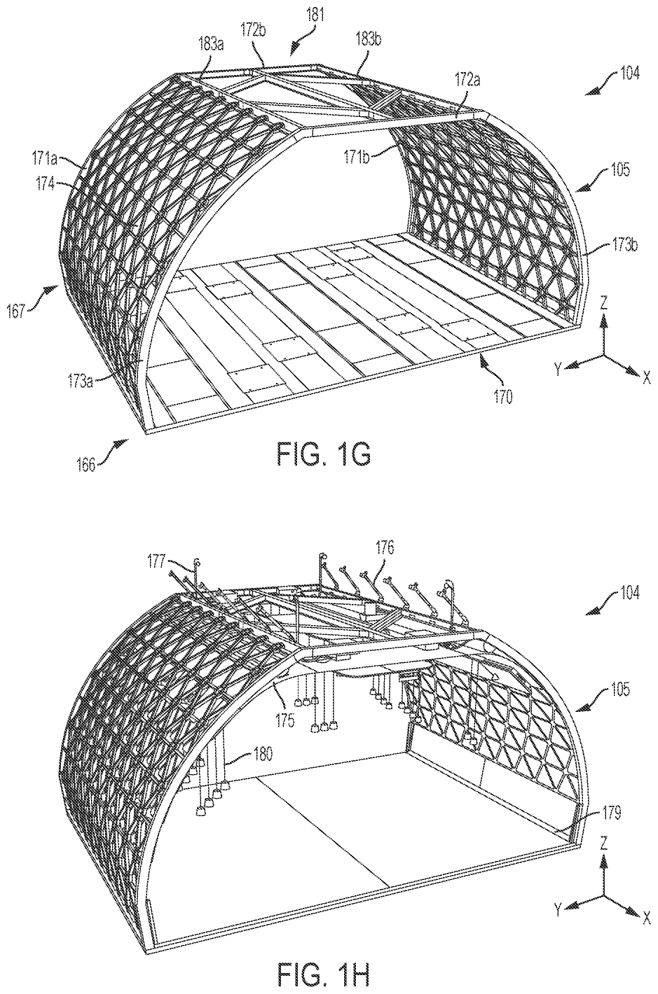

FIG. 1A shows an example embodiment of an aircraft 102 with a modular interior space and modules 104 distributed therein in accordance with example embodiments of the present disclosure. The modular interior can include one or more predetermined module-receiving locations, each location being configured to receive a module 104 of a predetermined shape and size, such that the module 104 can be readily installed (see, e.g., FIGS. 1E-1F). During flight, the modular interior of aircraft 102 can be populated with one or more modules 104 to form a modularized cabin and the remaining space can include conventional fixed structures (e.g., lavatory, galley, seating, etc.). Aircraft 102 can also include a centralized (or common) utility bus 106 with interfaces positioned at one, some, or all of the predetermined module locations for providing and/or receiving power, data, other electrical communications, air (e.g., venting, air conditioning, heating, oxygen), water (e.g., potable, grey water, wastewater), lighting, and the like.

Although a particular structural aircraft design is depicted in FIG. 1A, any suitable aircraft type can utilize the modular embodiments described herein. For example, aircraft 102 can be designed and originally manufactured with a modular interior, or can be manufactured as a conventional passenger and/or freight aircraft that is then retrofitted with the modular interior. Aircraft 102 can carry passengers in a single level (as shown here) or a multi-level manner, in which case aircraft 102 can receive and house modules on any and all of the multiple levels. Aircraft 102 is depicted in FIG. 1A while located on an airport tarmac during a passenger and module loading and unloading phase.

As stated, at least a portion of the aircraft cabin can include a modular interior setup, in which modules can be quickly inserted and removed into at least a portion of the cabin or interior space of aircraft 102. In the embodiment depicted in FIG. 1A, the entire cabin portion of aircraft 102 can utilize modules 104. Each module 104 can be a separate and discrete unit that includes different available features as described herein (e.g., personalized cabins, first class seating, business class seating, economy seating, lounge, sleeping room, wellness center, workout room, theater room, sports viewing room, bathroom facilities, office galley, utility, etc.). As is depicted in FIG. 1A, a first two modules from the front of aircraft 102 (depicted in a partial section view of aircraft 102) can include conventional seating for passengers. Additional modules 104 (depicted in perspective view with the exterior of aircraft 102 depicted as a partial section view) can already be inserted into the interior of aircraft 104 and additional modules 104 can be in the process of being transported to be inserted into the airframe of aircraft 102 by module distribution truck 108.

FIG. 1B is a top down view and FIG. 1C is a side view of an example embodiment of aircraft 102. As seen best in FIG. 1B, the fuselage or main body of aircraft 102 includes a nose portion 110, an intermediate fuselage portion 112, and a tail portion 114. Aircraft 102 includes left and right main wings 121 and 122 and left and right horizontal stabilizers 123 and 124, respectively. A vertical stabilizer 125 is located on the top side of fuselage 112. The propulsion system for aircraft 102 can include any number of one or more engines, such as the two wing-mounted engines 127 and 128 shown here. The embodiments described herein are not limited to this or any other particular aircraft exterior arrangement.

A longitudinal axis 116 extends between nose and tail portions 110 and 114 along the length of intermediate fuselage portion 112 (e.g., parallel with a roll axis of aircraft 102). A lateral axis 117 extends perpendicular to longitudinal axis 116 generally even with wings 121 and 122 (e.g., parallel with a pitch axis of aircraft 102). Axes 116 and 117 define an X-Y plane as indicated in FIG. 1B, where a Z axis (e.g., a yaw axis of aircraft 102) is normal to the page.

Aircraft 102 can include any number of one or more module doors for the loading and unloading of modules. Module doors have dimensions sufficient to permit modules 104 to be easily inserted and removed from aircraft 102 (e.g., using cargo loading and unloading infrastructure to transport modules to an aircraft 102 and place them in the aircraft 102). Based on the location of the module doors, module insertion and removal can occur through the front, side, and/or rear portions of aircraft 102 along any direction in three-dimensional space. Once each module 104 enters and is aligned with the interior of aircraft 102, that module 104 is moved along longitudinal axis 116 to its desired position within intermediate fuselage portion 112.

Thus, in many of the embodiments described herein, each module 104 can be contained entirely within the outermost wall (e.g., the airframe) of aircraft 102 such that no surface of the module 104 comes into contact with the outside air during flight. In other approaches, such as concepts disclosed in U.S. Pat. Nos. 7,344,110 and 9,193,460, a removable portion of the aircraft has an exterior wall that itself forms the outermost wall (or surface) of the aircraft and contacts the outside air during flight. However, the present disclosure is not limited to only wholly contained modules 104 and, in certain other embodiments, modules 104 can include a surface that forms the outermost surface of aircraft 102.

Aircraft 102 can also include any number of one or more relatively smaller doors (e.g., smaller Z and/or X dimensions) that are sized for passenger loading and unloading. FIGS. 1B-1C depict a number of potential aircraft door placements that can be used with aircraft 102. In many embodiments, aircraft 102 would only have a subset of the number of doors described with respect to FIGS. 1B-1C. Six passenger doors (or potential door placements) 131-136 are shown that are relatively smaller than two module or freight side doors (or potential door placements) 141 and 142. In some embodiments, only one side door 141 or 142 would be present. Two emergency exit doors (or potential door placements) 137 and 138 are shown that are relatively smaller than passenger doors 131-136.

Side-located module doors 141 and 142 can be used for the lateral loading and unloading of modules 104 from the left and/or right sides of aircraft 102. As depicted here, module doors 141-142 are located between nose portion 110 and main wings 121-122, although module doors 141-142 can be located relatively farther aft, such as over main wings 121-122 or between main wings 121-122 and horizontal stabilizers 123-124. FIG. 1D is a perspective view of a portion of an example embodiment of aircraft 102 showing a module 104 during the loading process. Here, module 104 is located on a module carrier 160 and has been raised and aligned with an open left-side module door 141. Module 104 is ready for insertion into an interior 162 of aircraft 102.

In some embodiments, aircraft 102 can include a nose-located module door (not shown), such as the type of cargo loading door created by swiveling or otherwise separating nose portion 110 from fuselage portion 112, to allow module loading through nose portion 110 of aircraft 102. In some embodiments, aircraft 102 can include a rear-located module door 150 that can be raised and lowered (see FIG. 1C) to allow module loading through the rear or tail portion 114 of aircraft 102. In some embodiments, instead of the module door 150 configuration depicted in FIG. 1C, aircraft 102 can be configured such that tail portion 114 (with or without stabilizers 123-125) swivels or otherwise separates from fuselage 112 to allow loading of modules 104 from the tail of aircraft 102. While multiple door placements are described and can be present in a particular aircraft embodiment, aircraft 102 only requires one door or other access point that is large enough to receive modules 104.

If module doors are located at different positions along the length (between nose and tail) of aircraft 102, then module loading can take place through a door that is different from the door used for unloading. Such an arrangement permits the unloading and loading of modules 104 at the same time (e.g., simultaneously). For example, module loading (e.g., insertion of a module 104 from the exterior into the interior of aircraft 102) can occur through a relatively forward-located door (e.g., nose-located or side-located) while module unloading (e.g., removal of a module 104 from the interior of aircraft 102 to the exterior) can take place through a relatively more rearwardly-located door (e.g., a relatively more rearward side door or a rear-located or tail-located door). Conversely, module unloading could occur through a relatively forward located door (e.g., nose-located or side-located) while module loading can take place through a relatively more rearwardly located door (e.g., a farther aft located side door or a rear-located or tail-located door).

Such an arrangement also permits faster unloading and loading of modules 104 as multiple points of entry and exit are available. For example, module unloading through two (or more) module doors can occur at the same first time, while module loading through the two module doors can occur at the same, but later, second time. Certain modules 104 are position dependent—they can only be located on certain portions of the fuselage such as over the wing or the back of the fuselage. In some embodiments, certain modules 104 in proximity with a first module door can be unloaded while certain other modules 104 in proximity with a different second module door can be unloaded. Then a new module loading process can begin at one of two doors even if unloading is still occurring at the other of the two doors. During the module loading process, passengers can board a module that has already been properly loaded and secured onto the main floor of the fuselage while other modules 104 are being loaded. This can be done by providing a temporary wall to safely contain passengers within a loaded module and to prevent passengers from accessing areas of aircraft's 102 fuselage where other modules 104 are being loaded and installed.

FIG. 1E is a cross-sectional view depicting an example embodiment of aircraft 102 with multiple modules 104 (or locations for modules 104) within fuselage 112. Depending on the size of aircraft 102 and the size of each module 104, any number of one or more modules 104 can be housed within fuselage 112. Here, twelve modules 104-1 through 104-12 are located within fuselage 112. Each module 104 can be sized and shaped for a particular position within aircraft 102, such as modules 104-11 and 104-12, each of which has a tapered cross-sectional profile (in the X-Y plane) to permit placement in the rear-most position. Each module 104 can have a different length (e.g., compare module 104-1 with relatively longer module 104-2). The configuration and spacing of each module 104 can be modified to remain flexible in aircraft 102.

FIG. 1F is a conceptual view of positions or locations for receiving modules 104 within aircraft 102 (the body of which is not shown). In this embodiment, eight positions are depicted for modules 104-1 through 104-8. Forward area 164 and rearward area 166 are shown without modules 104 as those areas are reserved in this embodiment for modular installations that, in some embodiments, can be galleys, lavatories, seating, and the like. For example, variations in the fuselage Y-axis width and/or Z-axis height can make module placement relatively difficult and/or undesirable in these areas 164 and 166.

Aircraft 102 can also include internal structures that facilitate the movement and positioning of the modules 104 within the aircraft. In some embodiments, rollers, tracks, pulleys, drive systems, hooks, and similar devices can be used to allow modules 104 to be placed at a particular position within aircraft 102 once inserted through the cargo door. In some embodiments, the positioning within aircraft 102 can be automated, for example, based on positioning information providing to a computing system of aircraft 102 and/or a module 104. Once each module 104 is positioned within aircraft 102, it can be secured or locked into aircraft 102 at one or more locations (e.g., using fasteners, hooks, straps, magnetic forces, gearing mechanisms, etc.). In some embodiments, doors can be opened and/or walls retracted or removed along the length of aircraft 102 such that the modular interior can appear to an ordinary observer as similar to a conventional cabin with seams. Portions of the walls of modules 104 that are adjacent to the aircraft exterior can partially retract in a manner that allows unfettered access to aircraft features such as windows and emergency exit doors as desired.

Modules 104 that are loaded into aircraft 102 can be supplied with various services and utilities based on module features and needs. Although these services and utilities can be routed to modules 104 in a variety of ways, such as in a non-centralized point to point manner, in some embodiments at least a portion of the utilities can be routed along a centralized utility bus 106 (FIG. 1A) of aircraft 102. Centralized utility bus 106 can run beneath or along the underside of modules 104 (as shown in FIG. 1A) or can be positioned otherwise as desired. Centralized utility bus 106 can also run above and between modules 104 to connect various services and utilities from one module 104 to another. For example, a water line can run from a module in the aft of aircraft 102 to another module in the front of aircraft 102 by providing each module 104 in aircraft 102 with mating connectors that can automatically connect with corresponding mating connectors located on adjacent modules 104. The mating connectors can be blind mating connectors that enable connection with other corresponding blind mating connectors simply by sliding any two modules 104 together. While a centralized utility bus 106 is described, in other embodiments multiple utility buses can be used. Centralized utility bus 106 can include a plurality of fixed and/or movable connection points that can mate with corresponding connection devices of modules 104. Example connection point devices can include quick connection technologies such as magnetic connectors or servo-controlled connections points that automatically mate in response to a corresponding connection point. In some embodiments, configurations can be pre-designed such that the connection points of centralized utility bus 106 can automatically connect with the corresponding connection points of modules 104. For example, a configuration can be programmed into a computing system of aircraft 102 and/or modules 104 that defines the types of modules 104, the location of the modules within the aircraft 102, and the types of utilities needed by each module 104, the relative locations of connection points, any other suitable information relating to utilities, or any suitable combination thereof. For each type of resources (e.g., water, electrical, air), different connection points and/or blind mating connectors can be used. For electrical, magnetic-based blind connectors can be used. In another example, for air and water, a male-female coupling pair can be used to automatically connect air and water lines between each module 104. The connections between centralized utility bus 106 and modules 104 can be completed based on this configuration.

Example utilities that can be provided by centralized utility bus 106 can include air, water, waste, electricity, data, oxygen, etc. It will, however, be appreciated that other services and utilities can also be convenient and could readily be added to aircraft 102 using centralized utility bus 106 or one or more different buses. In an embodiment, some utilities can be independently generated or provided within modules 104 (e.g., waste can be stored and oxygen can be generated at a module 104) while other utilities (e.g., electricity, data, and water) can be provided by centralized utility bus 106. In some embodiments, certain zones of the aircraft can have certain utilities that typically do not need to be provided to the entire cabin, such as waste and water. Zones can be provided that include these utilities so that they do not need to be provided in modules 104 or on common utility bus 106. In this manner, certain modules 104 (e.g., a restroom module, galley, or shower) can be limited to certain zones within an aircraft that are compatible with the modules 104.

Each module 104 can have certain self-contained safety or emergency features such as fire extinguishers, sprinklers, air locks, floatation devices, and/or parachutes. The modular embodiments described herein allows greater flexibility in emergency situations, increasing the likelihood of positive outcomes.

FIG. 1G is a perspective view depicting an example embodiment of a support frame 105 of module 104. Here, a forward side of support frame 105 is indicated with numeral 166 and a rear or aft side is indicated with numeral 167. Support frame 105 can include a bottom wall or module floor 170, side frames 171a, 171b, 173a, and 173b, and a ceiling frame 172a and 172b such that frame 105 is a partially closed structure with a periphery that continually extends around the interior space of aircraft 102 within the Y-Z plane as indicated here. Stated differently, module 104 can extend in a 360 degree fashion about a longitudinal axis (e.g., the X-axis) of aircraft 102 passing through module 104. This enables frame 105 to bear substantial loads applied by structures and passengers within the interior of frame 105 and applied by those portions of aircraft 102 outside of but in contact with frame 105. The front side 166 and rear side 167 of module 104 are open to permit the movement of passengers between modules 104 (e.g., along the X-axis), although in some embodiments partial or complete walls can be erected in these positions as well. The interior area of frame 105 enclosed by module floor 170, side frames 171 and 173, and ceiling frames 172a and 172b can be referred to herein as the module enclosure. Additionally, side frames 171a and 171b can be referred to as aft-side frames, and side frames 173a and 173b can be referred to as forward-side frames.

In this embodiment, module floor 170 is a floor that lies substantially along an X-Y plane. Side frames 171a, 171b, 173a, and 173b are curved in a fashion that corresponds to the curvature of fuselage 112 (e.g., the exterior wall) of aircraft 102. Side frames pair 171a and 173a and pair 171b and 173b include a support lattice structure 174 formed from multiple interconnecting lattice frames. In each side frame, support lattice structure 174 is connected to a forward side frame (e.g., 173a), an aft side frame (e.g., 171b), and to a top or ceiling frame (e.g., 183a). Ceiling frame assembly 181 includes peripheral ceiling frames 172a, 172b, 183a, 183b, and multiple braces in between to reinforce frame assembly 181. Frame assembly 181 is positioned substantially in an X-Y plane (parallel to module floor 170). This embodiment of module 104 can be characterized as having a semi-cylindrical shape.

FIG. 1H is a perspective view of an example embodiment of module frame 105 after connection to additional structures for furnishing the interior of module 104 and for attaching module 104 to aircraft 102. Multiple tie rods 176 are located along peripheral ceiling frames 183a and 183b. Tie rods 176 connect module frame 105 to the interior of fuselage portion 112 of aircraft 102. Although not shown, one or more connections can be used to attach floor 170 to an interior dividing wall of aircraft 102 that would be beneath floor 170.

Electrical interfaces 177 are accessible at various locations along top wall 172. Here, each interface 177 includes a connector and a cable that is then routed to the desired location within module 104. Electrical interfaces 177 can supply power, communications, and/or data to (and receive one or more from) module 104. A climate conduit 178 is coupled to support frame 105 and can provide heating, cooling, or other ventilation to output ports (not shown) within module 104. Paneling 175 can be attached to the interior of module frame 105 along each of walls 170-173 to separate the passenger area from the various utilities and other support components running along module frame 105. Oxygen masks and tubing 180 are shown hanging within the interior of module 104. The oxygen tubing can be connected to oxygen canisters attached to lattice 174 behind paneling 175. A decompression venting device 179 can run along the base of the interior of frame 105 to permit rapid decompression venting from the interior of module 104.

Once modules 104 are inserted into the aircraft, locked into (or secured to) locations within aircraft 102, connected to utilities, connected to each other, and opened to provide access to hallways, windows, and exits, the modular configuration of the aircraft 102 can be complete. During aircraft operations, some or all modules 104 can be swapped after passengers unload from aircraft 102. Previously cleaned, stocked, and configured modules 104 can be provided for aircraft 102, obviating some or all of the need to individually clean and restock aircraft 102 in a high-cost environment (e.g., at the airport gate). Modules 104 can be returned to a centralized facility where cleaning and restocking can be performed by specialized personnel in an environment that is conducive to cost effective servicing (e.g., at a warehouse facility with customized cleaning equipment, devices, and personnel). Distribution centers can coordinate with flight control to efficiently deliver modules 104 to aircraft gates as planes arrive, and facilitate a quick and efficient turnaround of aircraft 102. In some embodiments, rather than removing aircraft 102 from service temporarily to deal with cabin problems (e.g., broken seats, equipment, electrical systems, utility systems, or lavatories), problem portions of a cabin can be replaced by replacing the problematic module 104. In some embodiments as described herein, only certain services can be swapped out (e.g., a lounge module used during an early evening flight can be replaced with a sleeping module for an overnight flight). In some embodiments, passengers can board module 104 before the module is loaded onto aircraft 102. For example, passengers can board module 104 at a passenger-boarding facility before the module is transported to the location of aircraft 102 for loading. In another example, passengers can board module 104 at a secure location away from the airport to avoid congestion at the airport. Once passengers finished boarding module 104, it can be directly transported to aircraft's 102 location at the airport without having to go through additional security.

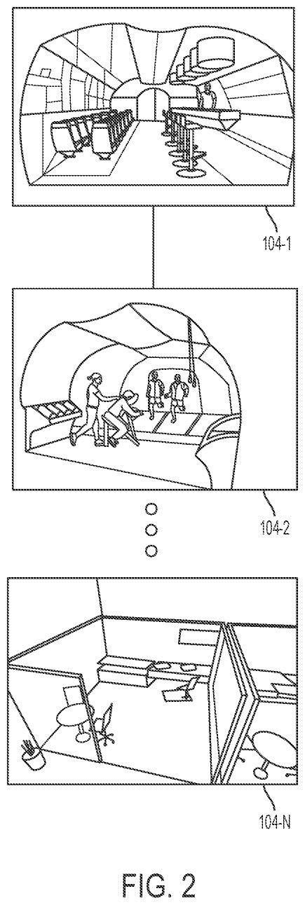

FIG. 2 shows multiple illustrative modules 104-1, 104-2, and 104-N in accordance with some embodiments of the present disclosure. As described herein, module types can be limited only by factors such as available space, utilities, and regulatory requirements. A module creation ecosystem can be provided that provides module designers with information about module dimensions, utilities and design rules. The dimensions of the module enclosure can specify an interior volume and associated X, Y, Z dimensions. Module designers and suppliers can create modules 104 that include module features are useful for many suitable purposes, such as conventional differentiated seating modules (e.g., first class, business class, premium economy class, economy class etc.), office modules (e.g., similar to small cubicles with workspace, chairs, monitors, high speed connections, etc.), meeting and business modules (e.g., chairs, desks and/or a conference space for a group of traveling coworkers or for meetings), family modules (e.g., for families traveling together, with small children, etc.), lounge or party modules (e.g., for all passengers, some passengers, or a group), wellness and exercise modules (e.g., for massage, weights, exercise equipment etc.), shower modules, sleeping modules, beauty modules (e.g., for makeup, hair care, etc.), gaming modules (e.g., having immersive or gaming experiences), or any other suitable module that can be designed to meet a customer need.

Customer access to different modules 104 can be managed in a variety of ways. For example, customers can purchase access to a particular module 104 prior to a flight, or in some embodiments, during flight. Passengers can be purchase blocks of time within modules 104, such that some passengers can cycle through aircraft 102 to different modules 104 during flight. In this manner, even long flights can provide a superior and more comfortable customer experience to conventional customers who might spend a portion of the flight in an economy seat but spend other parts of the flight circulating to one or two custom modules 104. In an embodiment, pricing for module usage could be dynamically adjusted before or during flight based on customer demand, thus balancing usage of the modules during flight.

An example lounge and dining module 104-1 is depicted in FIG. 2. Lounge and dining module 104-1 includes seating at tables and at a counter. Lounge and dining module 104-1 can be connected to centralized utility bus 106 and can receive and/or produce utilities such as water, waste, electricity, air, ventilation, data, or other. A dining module 104-1 such as the one shown in FIG. 2A could be operable to replace customary meal and/or food service on aircraft 102, or could supplement more traditional food service offerings.

An example spa and fitness module 104-2 includes features for exercise such as treadmills, stationary bikes, or other fitness equipment. Module 104-2 can also be equipped with massage chairs, or facilities for other treatments such as nail, hair, or face treatments. In one embodiment, fitness module 104-2 is equipped with locker and shower facilities, while in other embodiments such services can be provided at a separate module.

An example office/workspace module 104-N includes equipment for office usage such as a computer, printer, photocopier, and other accessories. Each of these components can be physically attached and customized in order to prevent unwanted movements during flight. Multiple work cubes or pods can be provided with soundproofing, higher speed connections, telepresence equipment, and other similar workplace equipment to facilitate the efficient use of the workspace.

Facilitating a module-based cabin interior system in this manner can provide advantages to aircraft manufactures and purchasers, who can be able to separate industrial design of the aircraft platform from design of an aircraft interior. Once a design is complete and a customer has placed an order, the aircraft may require little customization, since the principle mode of customization may be performed with modules 104, the purchase of which may be performed separately from aircraft 102. Even if aircraft 102 is provided with a core set of modules 104 that will likely remain in the aircraft during most flights (e.g., conventional seating modules, a galley module, and a head module), modules 104 can be constructed in parallel with aircraft 102 and “final assembly” will simply require inserting modules 104 into aircraft 102. In this manner, the lead time for building passenger aircraft 102 can be significantly reduced. An ecosystem for module developers can allow for increased testing and acceptance of new interior designs, which can be updated on a frequent and even per-flight basis.

### Example Embodiments of Lattice Structures

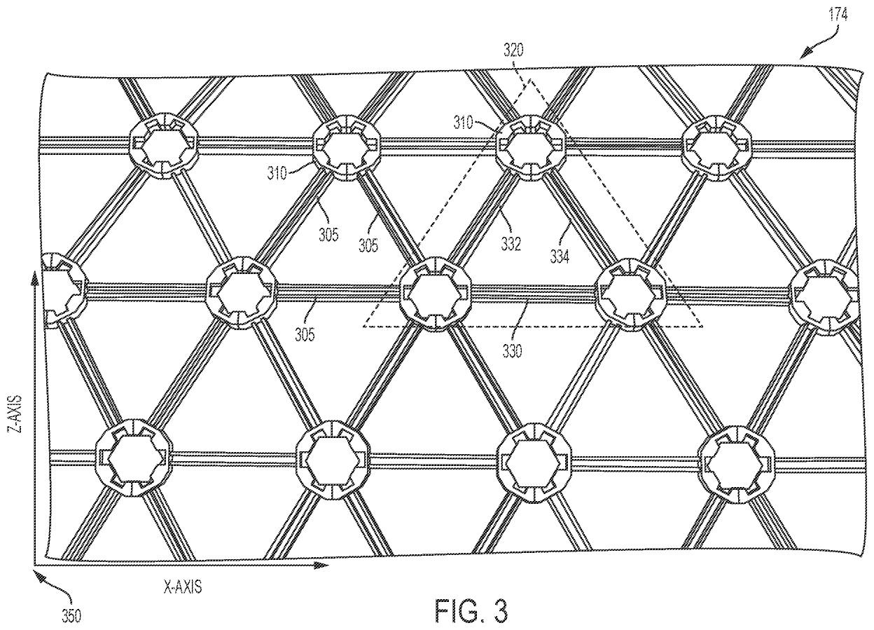

FIG. 3 illustrates lattice structure 174 in accordance with some embodiments of the disclosure. Lattice structure 174 includes multiple beam elements 305 and hubs 310. Each beam element 305 can be coupled to at least one hub 310. One or more of beam elements 305 in lattice structure 174 can also be truss elements. In the embodiment depicted here, each hub 310 is connected to six beam elements 305 that can be, in turn, connected to adjacent hubs 310. This arrangement can form multiple triangular-shaped-sub-lattice structures 320. Each beam element 305 can be designed and manufactured to withstand axial loading and bending forces imparted upon the structure by the airframe and the structures mounted within module 104. Other embodiments can be used as well, such as where each hub 310 couples to 3, 4, 5, 7, or 8 beam elements 305, or where the various hubs 310 within lattice structure 174 can couple to a different number of beam elements (e.g., some hubs 310 couple to 3 beam elements 105, while other hubs 310 within the same lattice couple to a different number of beam elements 105).

Each of the triangular-shaped sub-lattice structures 320 is formed by three hubs 310 and three beam elements 305. The three beam elements 305 can be referred to as a longitudinal beam or longitudinal stringer 330, a forward-traversing beam 332, and an aft-traversing beam 334. Given the origin 350 depicted here, the positive x-direction (forward direction) points toward the nose of the plane and the negative x-direction (aft direction) points toward the aft of the plane. The z-direction equates to height from the origin, with increasing z values indicated on the axis shown here.

Forward-traversing beam 332 traverses between a relatively lower x and lower z value to a relatively higher x and higher z value. As shown in FIG. 3, forward-traversing beam 332 traverses between the lower left and the upper right. Aft-traversing beam 334 traverses from a relatively higher x and higher z value to a relatively lower z and higher x value. As shown here, aft-traversing beam 334 traverses from the upper left to the lower right. Similarly, longitudinal stringer 330 traverses from a lower x value to a higher x value along the x-axis, with zero or minimal change in the z direction (e.g., directly from left to right as shown here).

As depicted in FIG. 3, most of the sub-lattice structures 320 are adjacent other sub-lattice structures 320, and thus for those sub-lattice structures 320, each beam 305 is shared by two adjacent sub-lattice structures 320, and each hub 310 is shared by six adjacent sub-lattice structures 320. As noted, however, other configurations are possible. Further, as depicted in FIG. 1G, those sub-lattice structures 320 at the perimeter or frame boundary of lattice 174 can be a partial sub-lattice structure 320. For example, sub-lattice structures 320 directly adjacent to (or directly coupled with) side frames 171a, 171b, 173a, and 173b can be bisected by that side frame, so that each bisected sub-lattice structure 320 is half the size of those sub-lattice structures not on the lattice perimeter. By way of further example, sub-lattice structures 320 adjacent floor 170 or top frames 183a, 183b can have an area substantially less than half that of sub-lattice structures 320 not on the lattice perimeter.

In some embodiments, each beam element 305 of sub-lattice structure 320 can have the same cross-sectional profile and/or the same thickness. For example, each beam element 305 can have a U-shaped, V-shaped, O-shaped, T-shaped, or C-shaped cross-section. Alternatively, each beam element of sub-lattice structure 320 can have the same cross-sectional profile but one or more of the beams can have different thicknesses. The cross-sectional profile of stringer 330 can also be different than the cross-sectional profiles of forward and aft traversing beams 332 and 334, which can themselves have the same cross-sectional profile. Additionally, each beam element 305 of sub-lattice structure 320 can have a different cross-sectional profile and thickness. For example, stringer 330 can have an I-shaped cross section, forward traversing beam 332 can have a U-shaped cross section, and/or aft traversing beam can have a V-shaped cross section. In some embodiments, one or more beam element can be removed from sub-lattice structure 320.

In some embodiments, hubs 310 can be hexagonally shaped to distribute lateral forces along the lattice structure. Hexagonal hubs 310 can also act as interface points for cabin interior components, such as power outlets, cabin panels, and cabin fixtures. The hexagonal structure can create equilateral triangles where the interior paneling attaches to the walls of cabin module 104, which creates modular interface points for attaching cabin interior components. Additional details on hubs 310 are provided below. Cabin fixtures can be coupled to hubs 310 using tie rods, pin brackets, bolts and nuts, aviation grade adhesive, mechanical fasteners, weldments, etc.

In some embodiments, sub-lattice structure 320 can have different size by varying the length of each beam element 305. Sub-lattice structure 320 can be selectively sized such that stringers 330 are located at specific heights from module floor 170 for supporting internal aircraft and/or cabin components such as one or more water lines, storage bins, door frames, venting panels, cabin fixtures (e.g., beds, bar, table, spa, etc.) and the like. Stringers 330 located at those heights can also be thicker than stringers 330 at other heights in order to support the proper weight and forces exerted by fixtures affixed to module frame 150 at those heights. Alternatively, the entire sub-lattice structures 320 located at heights where cabin fixtures are located can be strengthened with beam elements with larger load-carrying capacity by using a combination of stronger material (e.g. titanium) and/or different cross-sectional profile (e.g., I-shaped cross-section). The lattice can be divided into functional zones where equipment pertaining to a specific function are present within only the designated functional zone. For example, each functional zone can be a different range of Z height within the lattice, such that the zones are stacked upon each other. In an example embodiment, a zone at the lowest Z height can be for air extraction, the next highest zone can be for furniture attachments, the next highest zone can be for lighting and/or oxygen passenger provisions, and the highest zone can be for air intake. Other arrangements can be used as well.

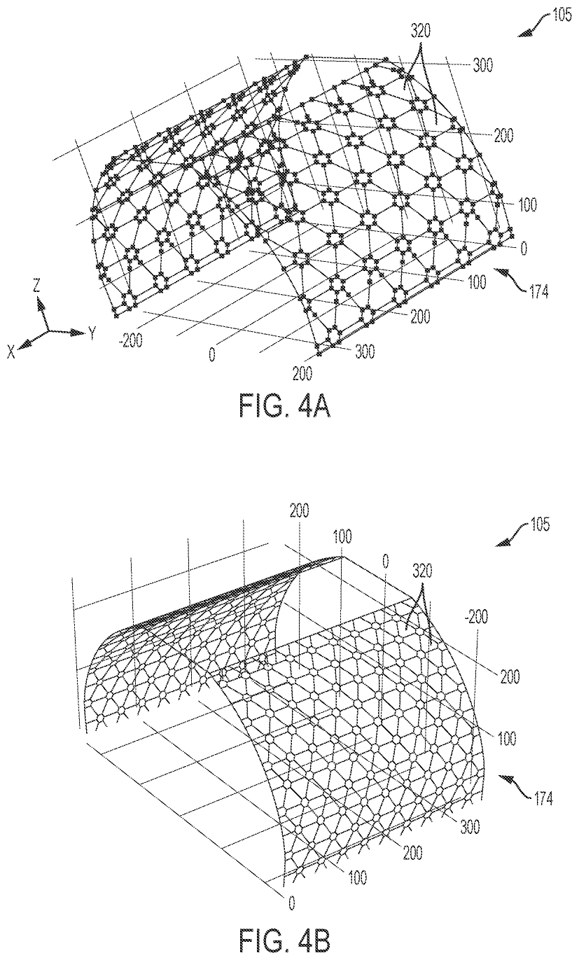

Variation to the length of each beam element 305 will also vary the lattice density of lattice structure 174 (e.g., the number of sub-lattice structures 320 per unit of area). FIGS. 4A and 4B depict similarly sized frames 105 with lattice structures 174 having different lattice densities. Lattice structure 174 of FIG. 4A has a relatively lower lattice density than that of FIG. 4B. For example, the port side of frame 105 of FIG. 4A has 55 complete sub-lattice structures 320, while the port side of frame 105 of FIG. 4B has 153 complete sub-lattice structures 320.

Different lattice structures 174 can be have regulatory certification for different uses. For example, lattice structure 174 of FIG. 4A can be certified for modules with relatively light to medium weight fixtures and/or load-carrying capacity, such as a module without conventional passenger seating (e.g., a work or office module, or others). Lattice structure 174 of FIG. 4B can be certified for modules with relatively heavier weight fixtures and/or load-carrying capacity, such as a module with conventional passenger seating (e.g., tightly stacked rows of 6-12 passengers per row) or other cabin types having heavy fixtures (e.g., restaurant, exercise facility).

The density of lattice structures 174 for each of cabin modules 104 within an aircraft 102 can be selected based on the configuration or intended use of each module 104. Aircraft 102 can have one or more cabin modules 104 with different lattice densities, different lattice beam thicknesses, different support frame (e.g., 172a, 173a, 173b, 183a, 183b, etc.) thicknesses, and/or different materials (e.g., aluminum, steel, titanium, carbon fiber, etc.). For example, a lounge and dining module 104 can include heavy fixtures such as a beverage dispenser, a bar table with furniture, refrigeration equipment, food preparation & heating equipment, additional water resources, waste disposal resources, etc. To support these additional load requirements, a lattice structure 174 having a relatively high lattice density (see, e.g., FIG. 4B) can be used. Otherwise, a relatively lighter duty cabin module 104 such as an office-workspace module can have a lower lattice density (see, e.g., FIG. 4A).

As an additional example, a spa and fitness module 104 can include large exercising equipment (e.g., treadmills, stationary bikes, weight & strength machine) and resource intensive facilities such as restrooms and showers. For a heavy loading cabin module such as this, a lattice structure with a relatively higher lattice density (see, e.g., FIG. 4B) and/or locally reinforced sub-lattice structures 320 can be used in order to provide proper support and to meet the required crash loading conditions at maximum payload. To reinforce a lattice structure 174 in one or more locales or portions within the lattice, one or more sub-lattice structures 320 can be strengthened by using relatively thicker lattice beam elements 305 where higher loads are coupled to the lattice structure. Alternatively, sub-lattice structures 320 can be strengthened by using beam element with larger load-carrying capacity made with a combination of stronger material (e.g. titanium) and/or different cross-sectional profile (e.g., I-shaped cross-section).

However, to save weight, in some embodiments not all sub-lattice structures 320 of the lattice are reinforced. For example, any sub-lattice structures 320 where heavy cabin fixtures (e.g., exercise equipment, shower facilities) are anchored can be reinforced with beam elements 305 having relatively thicker cross-sections or with beam elements with larger load-carrying made with combination of stronger material (e.g. titanium) and/or different cross-sectional profile (e.g., I-shaped cross-section). Additionally, a sub-lattice structure 320 can be reinforced by having one or more of its hubs 310 and/or beam elements 305 coupled to the aircraft fuselage with a tie rod. Also, a sub-lattice structure 320 can be reinforced by coupling one or more additional beams to the lattice, either over and aligned with the existing beams 305 or between beams 305 and/or hubs 310 across the triangular central space of the sub-lattice structure 320. Additional details on reinforced portions of a lattice structure and tie rods are provided below.

Where a range of values are set forth herein, each intervening value, to the tenth of the unit of the lower limit unless the context clearly dictates otherwise, between the upper and lower limit of that range is encompassed within this disclosure and can be claimed as a sole value or as a smaller range. Where the stated range includes one or both of the limits, ranges excluding either or both of those included limits are also included in the disclosure.

Where a discrete value or range of values is set forth, it is noted that that value or range of values may be claimed more broadly than as a discrete number or range of numbers, unless indicated otherwise. For example, each value or range of values provided herein may be claimed as an approximation and this paragraph serves as antecedent basis and written support for the introduction of claims, at any time, that recite each such value or range of values as “approximately” that value, “approximately” that range of values, “about” that value, and/or “about” that range of values. Conversely, if a value or range of values is stated as an approximation or generalization, e.g., approximately X or about X, then that value or range of values can be claimed discretely without using such a broadening term. Those of skill in the art will readily understand the scope of those terms of approximation. Alternatively, each value set forth herein may be claimed as that value plus or minus 5%, and each lower limit of a range of values provided herein may be claimed as the lower limit of that range minus 5%, and each upper limit of a range of values provided herein may be claimed as the upper limit of that range plus 5%, and this paragraph serves as antecedent basis and written support for the introduction of claims, at any time, that recite those percentile variations.

No claim based on this disclosure is to be interpreted as limited to a particular value or range of values absent explicit recitation of that value or range of values in the claim. Values and ranges of values are provided herein merely as examples.

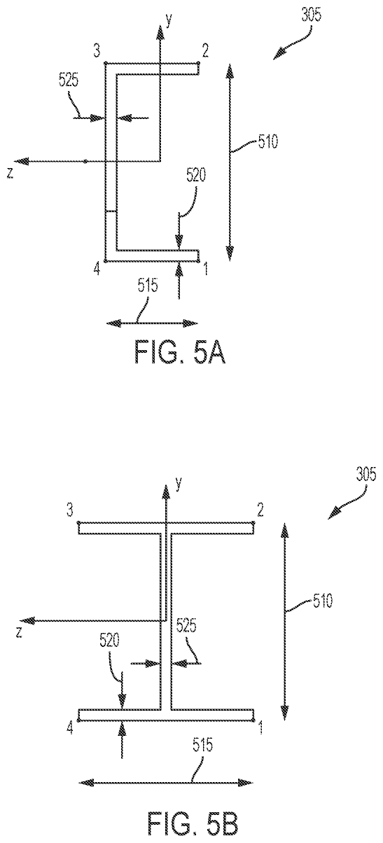

FIG. 5A illustrates a cross-sectional profile of a lattice beam element 305 in accordance with some embodiments of the disclosure. As shown, the cross-section profile can be C-shaped. In some embodiments, the cross-sectional profile can have other shapes such as, but not limited to, an O-shape, an L-shape, an I-shape, a triangle-shape, a V-shape, and the like. For example, forward and aft-side frames 171 and 173 can have an I-shaped cross-section similar to the cross-sectional profile shown in FIG. 5B.

In some embodiments, the cross-section of forward-side frames (e.g., 173a, 173b) and aft-side frames (e.g., 171a, 171b) has the same characteristics and features as the cross-sectional profile depicted in FIG. 5A, which includes a height 510, a width 515, a flange thickness 520, and a core thickness 525. In some embodiments, height 510 has a range of 65 millimeters (mm) to 120 mm, width 515 has a range of 40 mm to 100 mm, flange thickness 520 has a range of 8 mm to 20 mm, and lastly core thickness 525 also has a range of 8 mm to 20 mm.

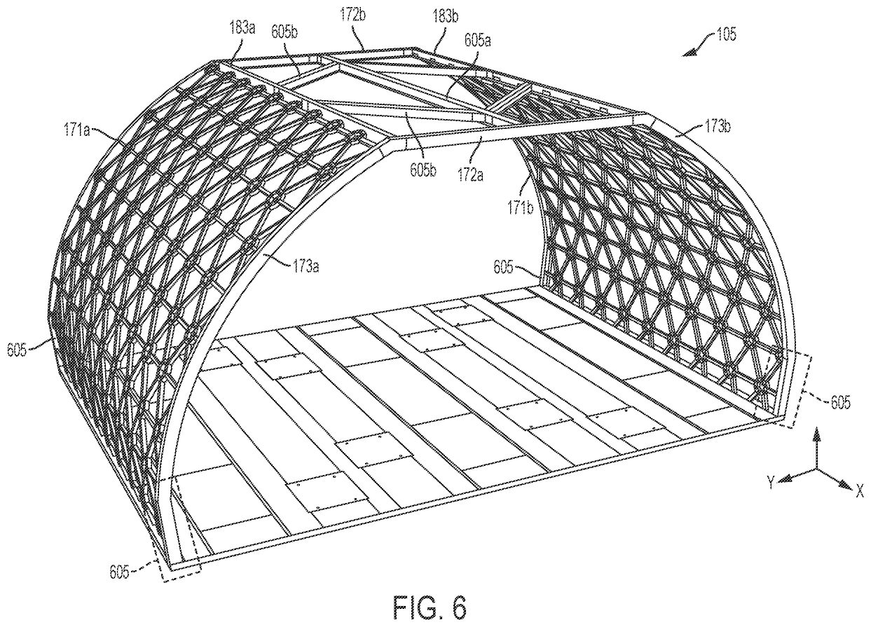

FIG. 6 illustrates module frame 105 in accordance with some embodiments of the disclosure. As previously described, module frame 105 includes aft-side frames 171a and 171b and forward-side frames 173a and 173b. In some embodiments, each of the side frames includes a bottom frame portion 605, which can have the same cross-sectional profile and overall thickness as the rest of the side frame. In some embodiments, bottom frame portion 605 is thicker than the rest of the side frame.

Top or ceiling frames (e.g., 172 and 183 of FIG. 6) can have a cross-sectional profile like that of FIG. 5A. In some embodiments, height 510 of ceiling frames has a range of 70 mm to 120 mm, width 515 of ceiling frames has a range of 45 mm to 80 mm, and thicknesses 520 and 525 of ceiling frames both have a range of 3 mm to 10 mm.

In one embodiment, for relatively light duty cabin modules, ceiling frames 172 and 183 can have a first cross-sectional profile or load-bearing characteristic set (e.g., tensile stress, compression stress, etc.). For relatively heavier duty cabin modules, ceiling frames 172 and 183 can have a second cross-sectional profile or load-bearing characteristic, where the second cross-sectional profile is relatively thicker than the first cross-sectional profile, or the second load-bearing characteristic set is of greater magnitude than the first load-bearing characteristic set. In some embodiments, cabin frame module 105 can include a center brace 605a and a plurality of cross braces 605b for reinforcing ceiling frames 172 and 183. Center brace 605a runs longitudinally down the center of the ceiling frame assembly. Alternatively, the ceiling frame assembly can have more than one center brace 605a. Cross braces 605b can couple center brace 605a to top frames 183a and 183b. Each brace 605b can be coupled to center brace 605a and to frame 183a or 183b at an angle. For example, frame 183a can be coupled to center brace 605a by two braces 605b. In one embodiment, each brace has a cross-sectional profile like that depicted in FIG. 5B, which includes a height 555, a width 560, a flange thickness 565, and a core member thickness 570. In some embodiments, height 555 has a range of 65 mm to 100 mm, width 560 has a range of 30 mm to 80 mm, thickness 520 has a range of 3 mm to 20 mm, and thickness 525 also has a range of 3 mm to 20 mm. It should be noted that each brace can have any other desired type of cross-sectional profile such as that shown in FIG. 5B and described as alternatives to that of FIG. 5B.

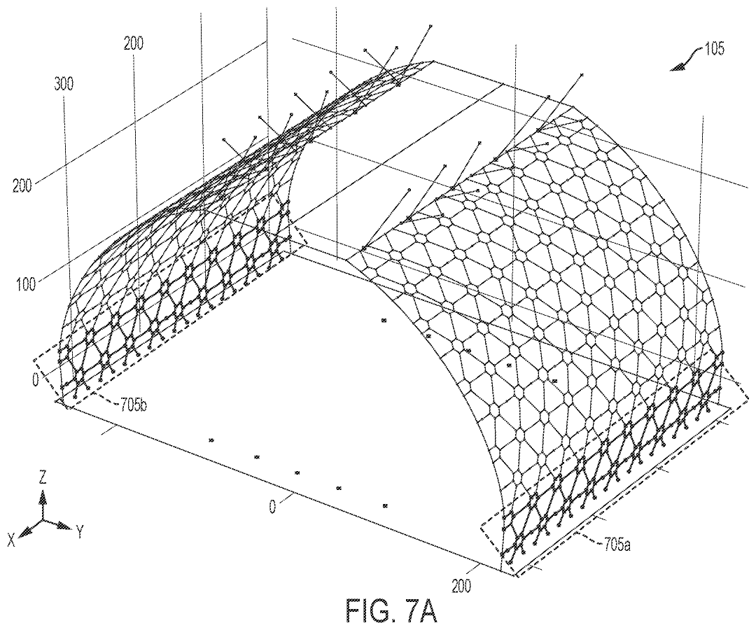

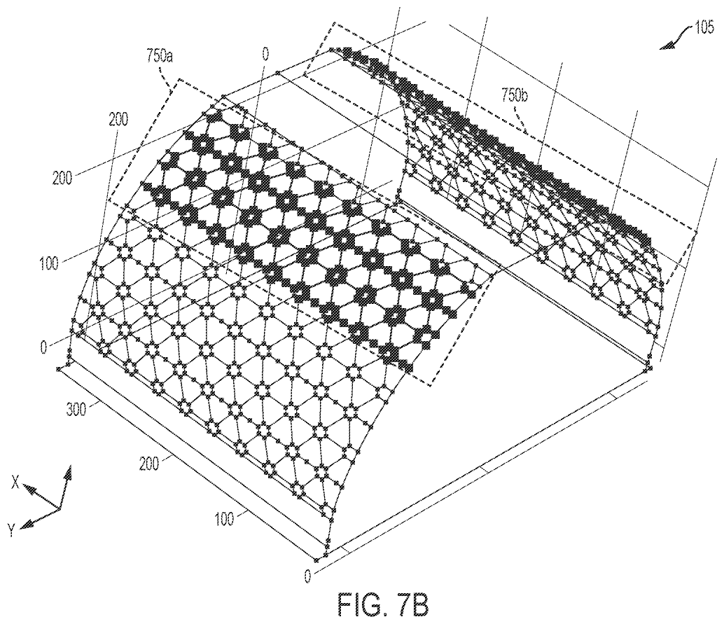

FIG. 7A illustrates a module frame 105 in accordance with some embodiments of the disclosure. As shown, module frame 105 includes a port side bottom frame portion 705a and a starboard side bottom frame portion 705b. Structurally, both portions can be identical and can have a cross-sectional profile identical to those depicted in FIGS. 5A and 5B. Alternatively, each bottom frame portion 705 can have a different cross-sectional shape and/or thickness profile depending on the type of fixtures affixed thereto. For example, a spa can be affixed to one of the bottom corners of module frame 105, or to another location in or near bottom portion 705 itself, and thus the bottom frame portion 705 in proximity to or coupled to the spa can have a thickness profile different than the other bottom frame portion 705 of module frame 105 (or those of other module frames 105). Both portions 705a and 705b are depicted as covering the entire x-axis length of the constituent lattice, although portions 705a and 705b can be only a part of that length.

In some embodiments, height 510 of bottom frame portion 705 has a range of 25 mm to 60 mm, width 515 of bottom frame portion 705 has a range of 20 mm to 60 mm, thickness 520 of bottom frame portion 705 has a range of 3 mm to 15 mm, and lastly thickness 525 of bottom frame portion 705 also has a range of 3 mm to 15 mm.

In an embodiment of a relatively lighter duty cabin modules 104 (e.g., a work office module), each bottom frame portion 705 can have a first cross-sectional profile or load-bearing characteristic set (e.g., tensile stress, compression stress, etc.). For relatively heavier duty cabin modules, (e.g., spa, restaurant module), each bottom frame portion 705 can have a second cross-sectional profile or load-bearing characteristic, where the second cross-sectional profile is relatively thicker than the first cross-sectional profile, or the second load-bearing characteristic set is of greater magnitude than the first load-bearing characteristic set.

FIG. 7B illustrates a module frame 105 in accordance with some embodiments of the disclosure. Module frame 105 includes a port side top frame portion 750a and a starboard side top frame portion 750b. Both portions can be structurally identical and can have a cross-sectional profile identical to those depicted in FIGS. 5A and 5B. Alternatively, depending on the type of fixtures affixed to each top frame portion, portions 750a and 750b can each have a different cross-sectional shape and/or thickness profile. Both top frame portions 750a and 750b are depicted as covering the entire x-axis length of the constituent lattice, although portions 750a and 750b can be only a part of that length. Each top frame portion 750 can cover an area that covers an entire upper half of the constituent lattice structure. Alternatively, each top frame portion 750 can cover an area smaller or larger than the entire upper half of the constituent lattice structure. Additionally, each top frame portion 750 can have a cross-sectional profile or load-bearing characteristic similar to bottom portion 705a.

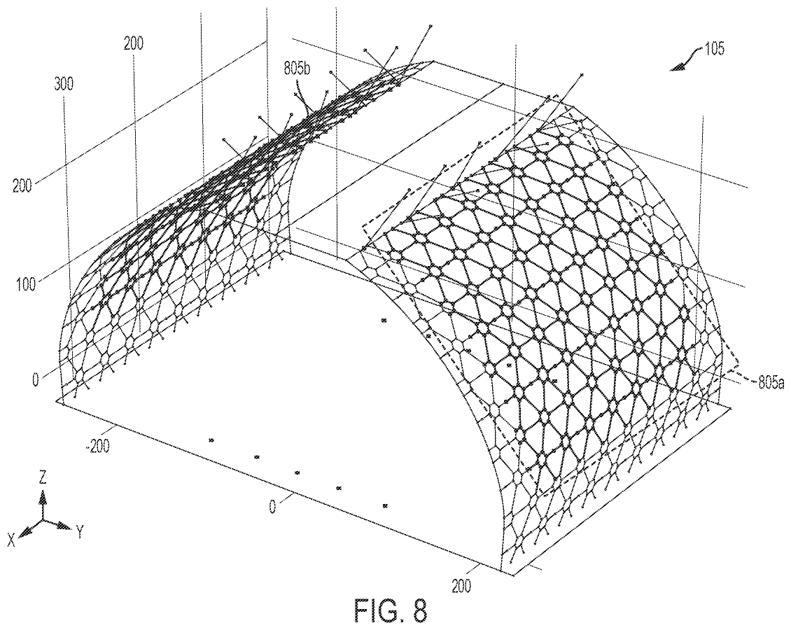

FIG. 8 illustrates a module frame 105 in accordance with some embodiments of the disclosure. Here, module frame 105 includes a port middle lattice portion 805a and a starboard middle lattice portion 805b. Each of the middle lattice portions 805 can have identical cross-sectional shape and thickness profiles. Alternatively, each middle lattice portion 805a or 805b can have a different cross-sectional shape and/or thickness profile. In some embodiments, middle lattice portions 805 have a cross-sectional profile like that depicted in FIG. 5A. The cross-sectional shape and/or thickness profile of each middle lattice portion 805a or 805b can depend on the type of fixtures attached in proximity to or directly to that middle lattice portion 805a or 805b. For example, a shower facility can be affixed to the port side of module frame 105, thus the port side middle lattice portion 805a can have a cross-sectional shape and/or thickness profile different than the starboard side middle lattice portion 805b.

In some embodiments, each of the middle lattice portions 805 has the following thickness profile: height 510 has a range of 20 mm to 40 mm; width 515 has a range of 20 mm to 40 mm; thickness 520 has a range of 3 mm to 10 mm; and thickness 525 of bottom frame portion 705 also has a range of 3 mm to 10 mm.

In some embodiments of a relatively light duty cabin module 104 (e.g., work office cabin), each of the middle lattice portions 805 can have a first cross-sectional profile or load-bearing characteristic set (e.g., tensile stress, compression stress, etc.). For relatively heavier duty cabin modules, (e.g., spa, restaurant module), each of the middle lattice portions 805 can have a second cross-sectional profile or load-bearing characteristic set, where the second cross-sectional profile is relatively thicker than the first cross-sectional profile, or the second load-bearing characteristic set is of greater magnitude than the first load-bearing characteristic set.

In some embodiments, port side middle lattice portion 805a can have a different thickness profile than starboard side middle lattice portion 805b as different cabin fixtures and/or resources can be affixed differently on each side of the cabin module. Any resulting load imbalances between the port and starboard sides within a cabin module can be resolved by distributing load differently (unevenly) on other cabin modules so that the load is balanced on both the port and starboard sides for the entire fuselage. In this way, the aircraft is load or weight balanced along its longitudinal axis.

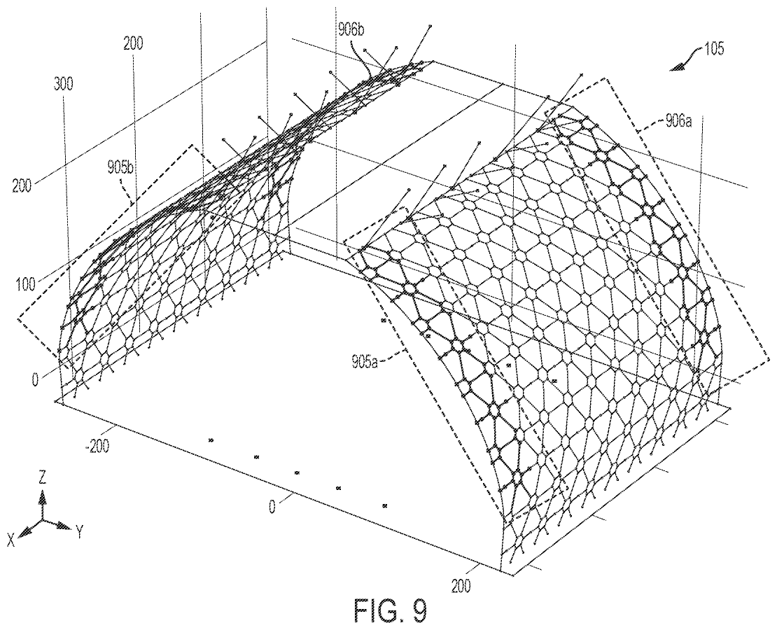

FIG. 9 illustrates a module frame 105 in accordance with some embodiments of the disclosure. Here, the indicated side lattice portions 905a and 905b are present on the forward sides of frame 105 and portions 906a and 906b are present on the aft sides of frame 105. Each of side lattice portions 905 and 906 can have identical cross-sectional shape and thickness profiles. Alternatively, each side lattice portion 905a, 905b, 906a, or 906b can have a different cross- sectional shape and/or thickness profile. In some embodiments, side lattice portions 905 and 906 have a cross-sectional profile like that depicted in FIG. 5A. The cross-sectional shape and/or thickness profile of each side lattice portion 905 and 906 can depend on the type of fixtures attached in proximity to or directly to that side lattice portion 905 or 906. For example, a shower facility can be affixed to the port side of module frame 105, thus the port side lattice portion 905a and/or 906a in closest proximity to the facility can have a cross-sectional shape and/or thickness profile different than the starboard side lattice portions 905b and 906b.

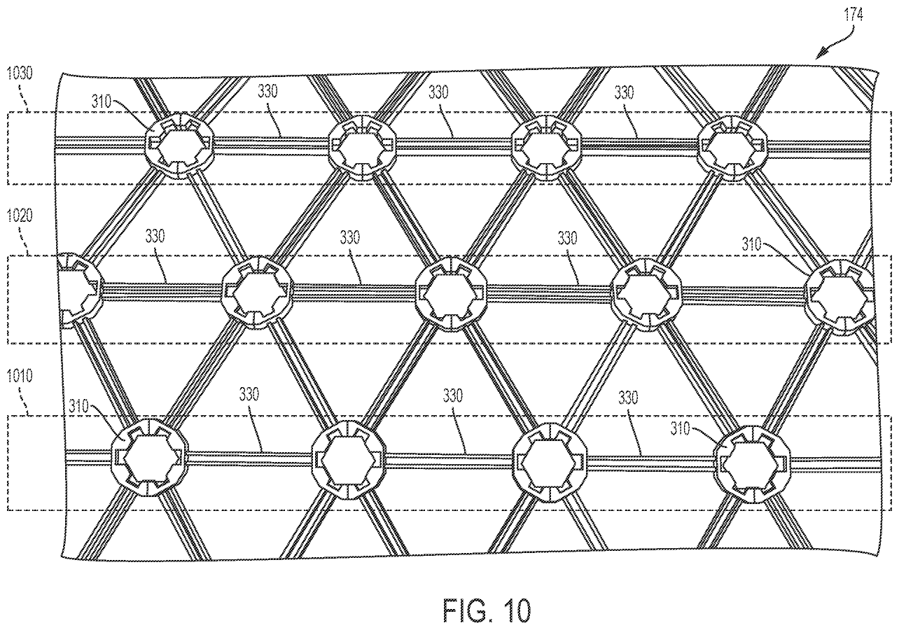

FIG. 10 illustrates lattice structure 174 having a variable thickness profile in accordance with some embodiments of the disclosure. As shown in FIG. 10, a longitudinally-traversing sub-frame (LTF) 1010 is formed by a plurality of hubs 310 and a plurality of stringers 330. Although not shown, the ends of LTF 1010 are coupled to side frames 171a and 173a (or side frames 171b and 173b).

Lattice structure 174 also includes LTFs 1020 and 1030. LTF 1020 is formed by multiple hubs 310 and stringers 330. Similarly, LTF 1030 is formed by multiple hubs 310 and stringers 330. Each LTF can be a single stringer (no hub) spanning the entire length of lattice structure 174. Both LTFs 1020 and 1030 are securely attached (not shown) to the side frames (e.g., 171a, 171b, 173a, and 173b) of cabin module frame 105. Although only three LTFs 1010, 1020, and 1030 are shown, lattice structure 1000 can have more than three LTFs, which can depend on the overall size of the aircraft fuselage and/or the type of fixtures being installed in the cabin module with cabin module frame 105.

For this and all embodiments described herein, variations in load-bearing characteristics (e.g., compression, tension, and others) will be described with reference to the example of varying cross-sectional thickness or overall cross-sectional thickness, although other techniques for varying load bearing characteristics can be used, such as the use of the use of different materials having relatively less or greater load-bearing characteristics, the addition of reinforcements to increase load-bearing characteristics, and/or the like. For example, a first material with certain tensile load-bearing characteristics can be used with a different second material having a relatively greater tensile load-bearing characteristic (e.g., instead of using a relatively thin beam and thick beam respectively). Also by example, instead of using a relatively thick beam to add tensile strength, one or more reinforcing structures can be added to a beam to increase its tensile strength.

Each LTF can have a different cross-sectional thickness and/or overall thickness. For example, the cross-section of LTF 1010 can be thicker than the cross-section of LTF 1020, which in turn can be thicker than the cross-section of LTF 1030. In other words, the cross-section of each stringer of LTF 1010 can be thicker than the cross-section of each stringer of LTF 1020. Similarly, the cross-section of each stringer of LTF 1020 can be thicker than the cross-section of each stringer of LTF 1030.

In some embodiments, the cross-section of an LTF proximal to (e.g., in close proximity to or directly adjacent to) the ceiling of cabin module frame 105 is thicker than the cross-section of a different LTF proximal to module floor 170. In other words, the thickness of the cross-sections of LTFs of frame 105 can be progressively thicker toward the ceiling of cabin module frame 105 and thinner in the opposite direction, which is toward module floor 170). In the unlikely event of an impact, everything inside the aircraft moves toward the point of impact, which, if at the bottom of the aircraft, causes frame 105 to compress at portions near module floor 170 and be placed under tension at portions near the ceiling. Accordingly, LTFs proximal to the ceiling of cabin module frame 105 can be thicker than LTFs proximal to module floor 170. Alternatively, the thickness of the cross-sections of LTFs of frame 105 can be progressively thicker toward module floor 170 and thinner toward the ceiling of cabin module frame 105.

The cross-sectional thickness of each LTF 1010, 1020, and 1030 can also or alternatively vary from the aft end to the forward end. For example, the cross-sectional thickness proximal to the forward end of frame 105 can be thinner than the cross-sectional thickness of the same LTF proximal to the aft end of frame 105. The thickness variation can be progressive-increasing progressively toward the aft portion, e.g., at a constant rate such as a taper. Alternatively, the thickness variation can be stepped, for example, where each beam section has a constant thickness, but a forward beam section has a thinner cross-sectional thickness than an aft beam section located along the same axis. The thickness variation can also be a combination of progressive and stepped. In an alternative embodiment, cross-sectional thicknesses proximal to the aft end of module 104 can be thinner than cross-sectional thicknesses proximal to the forward end.

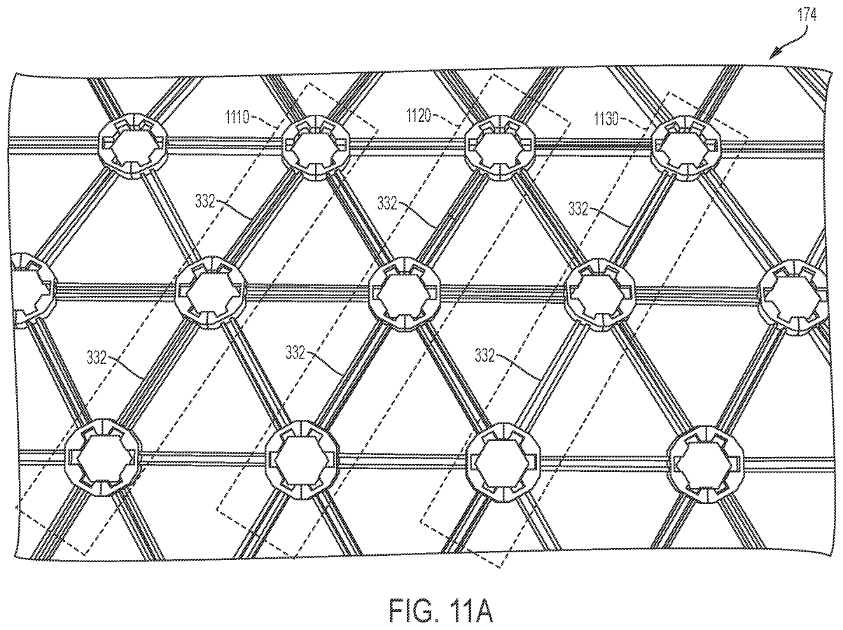

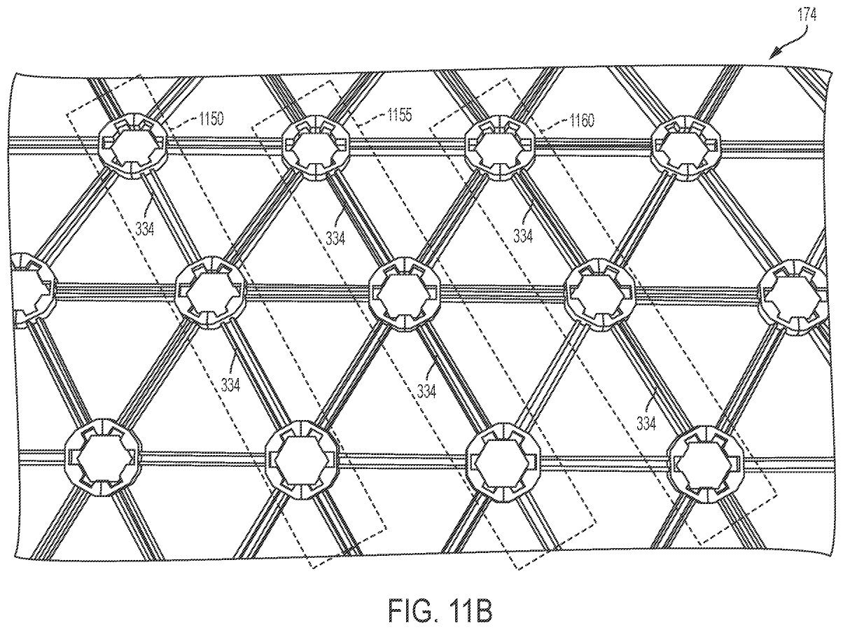

FIG. 11A illustrates lattice structure 174 with multiple forward-traversing sub-frames (FTF) 1110, 1120 and 1130, each of which can include one or more forward-traversing beams 332 and one or more hubs 310. In some embodiments, each FTF can be a single forward-traversing beam (without any hub) that spans across the entire diagonal length of lattice structure 174. In such embodiments, one end of the single forward-traversing beam can be coupled to module floor 170 and the other can be coupled to ceiling frame 183a. Each FTF can have a different cross-sectional thickness or overall cross-sectional thickness. FTFs that are proximally located to (or adjacent to) the aft portion of module frame 105 can be thicker than FTFs that are proximally located to the forward portion of module frame 105. In other words, FTF 1130 can be thinner than FTF 1120, which in turn can be thinner than FTF 1110. The thickness of each FTF can also or alternatively vary between the ceiling end (end proximal to ceiling frame 183) and the floor end (that proximal to module floor 170). In the unlikely event of an impact with an object near the front of the aircraft 102, the portion of an FTF proximal to the front of module frame 105 will likely experience compressive forces while the portion of a FTF proximal to the aft of module frame 105 will likely experience tensile forces. Thus, by having a larger thickness near the aft portion than the forward portion, each FTF will be able to better withstand the tensile and compressive forces at each respective end. These and other such configurations described herein can also result in weight savings. Accordingly, in some embodiments, the end portion of each FTF proximal to the ceiling of module frame 105 is thicker than the end portion of each FTF proximal to module floor 170. The thickness variation can be progressive, stepped, or a combination of both, as described herein.

FIG. 11B illustrates lattice structure 174 with multiple aft-traversing sub-frames (ATF) 1150, 1155 and 1160, each of which can include one or more aft-traversing beams 334 and one or more hubs 310. Each ATF can have a different cross-sectional thickness. In some embodiments, each ATF can be a single aft-traversing beam that runs the entire diagonal length of the ATF and, in such an embodiment, each ATF is hub-less. ATFs that are proximally located to the forward portion of module frame 105 can be thinner than ATFs that are proximally located to the aft portion of module frame 105. For example, ATF 1150 can be thicker than ATF 1155, which can be thicker than ATF 1160. The thickness of each ATF can also or alternatively vary from the ceiling end (end proximal to ceiling frame 183) to the floor end (end proximal to module floor 170). In some embodiments, the floor end of each ATF can be thinner than the ceiling end of each ATF and, as with the other embodiments, this variation can be progressive, stepped, or a combination of both. Alternatively, the floor end of each ATF can be thicker than the ceiling end of each ATF.

Each of LTFs, FTFs, and ATFs described above are formed by multiple hubs and lattice beam elements securely chained (attached) together, which can be referred to generally as chained-lattice frame member. Alternatively, each of LTFs, FTFs, and ATFs can be formed without hub 310. In some embodiments, each of the chained-lattice frame members of a lattice structure (e.g., 174) has the same cross-sectional shape and thickness profile. Alternatively, one or more of the chained-lattice frame members of a lattice structure can have a different cross-sectional shape and thickness profile. For example, a passenger service channel (PSC) for water, air, and electrical conduit can be installed along one or more of the chained-lattice frame members (e.g., LTF, FTF, ATF), thus chained-lattice frame members proximal (and/or adjacent) to the PSC can have a thicker thickness profile than other chain-lattice frame members of the lattice same structure.

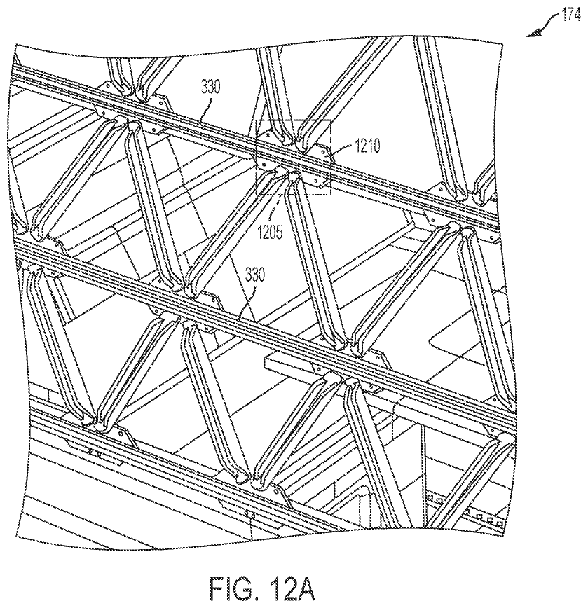

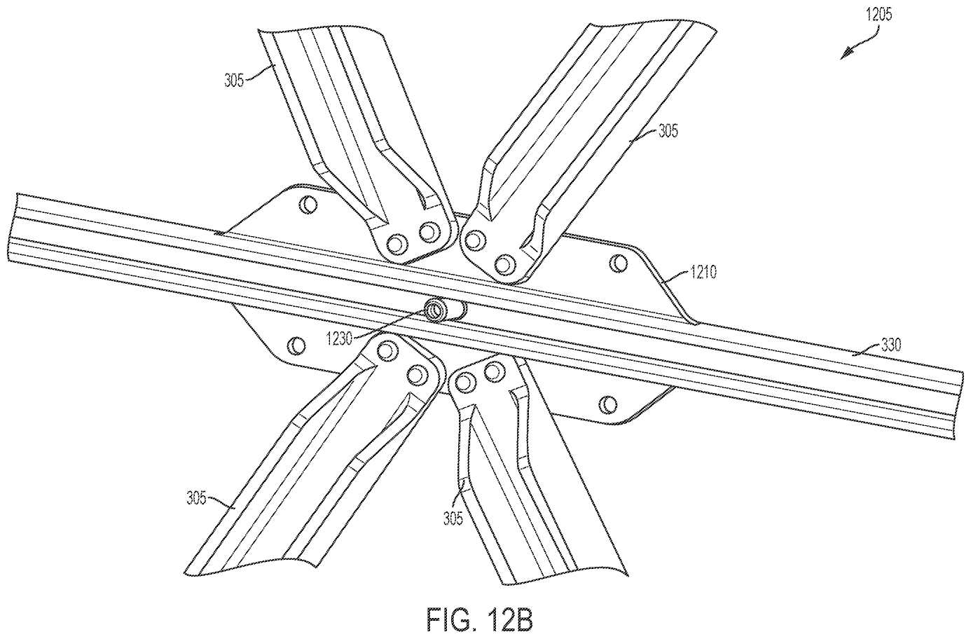

FIG. 12A illustrates lattice structure 174 without a hub in accordance with some embodiments of the disclosure. Lattice structure 174 can be hub-less at an intersection region 1205, where each beam is directly coupled to each other using weldments, pins, nuts & bolts, adhesive, or a combination thereof. In some embodiments, a single longitudinal stringer 330 can span across module frame 105, from the aft end to the front end of module frame 105. For example, a single stringer 330 can have one end directly coupled to aft side frame 171a and the other end directly coupled to front side frame 173a. In this embodiment, each beam element 305 can be directly coupled to stringer 330 at intersection region 1205. In some embodiments, a connection plate 1210 can be coupled (using weldments, adhesive, pins, nuts & bolts, etc.) over intersection region 1205 to provide additional strength to intersection region 1205. Connection plate 1210 can be installed in a way such that each beam and stringer at intersection region 1205 is also coupled to connection plate 1210. In some embodiments, connection plate 1210 can be directly coupled to stringer 330 and each beam element can be directly coupled to connection plate 1210, which essentially provides a large surface area to which other beam elements can be coupled.

FIG. 12B illustrates an example connection plate 1210 at intersection region 1205 in accordance with some embodiments of the disclosure. Connection plate 1210 can be a single component directly coupled to stringer 330. Alternatively, connection plate 1210 can have a first portion coupled to the top side (toward the ceiling of the aircraft's fuselage) and a second portion coupled to the bottom side (toward the floor of the fuselage). In this embodiment, connection plate 1210 is configured like a flange from stringer 330. Each portion of connection plate 1210 can be coupled to stringer 330 using weldments, adhesive, attachment pins, nuts and bolts, or a combination thereof. Each beam member 305 can be directly coupled to connection plate 1210 using weldments, adhesive, attachment pins, nuts and bolts, or a combination thereof. Connection plate 1210 can also include a mechanical fastener 1230 (e.g, pins, nuts and bolts, etc.) to couple connection plate 1210 to stringer 330.

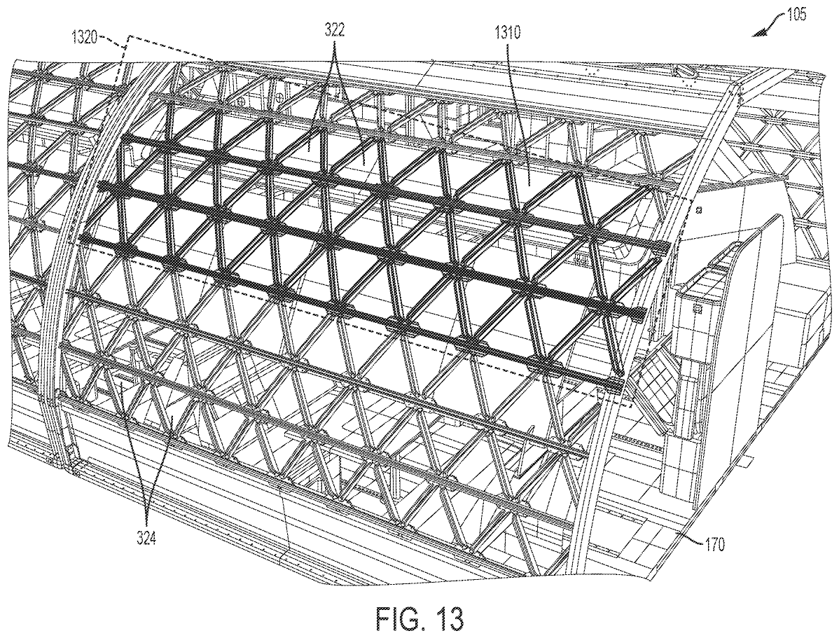

FIG. 13 illustrates a cabin module frame 105 having a plurality of fixtures 1310 (e.g., hatrack, passenger service channel (PSC)) affixed to various locations of an upper lattice frame portion (ULFP) 1320. As shown, module frame 105 can have heavy fixtures affixed to ULFP 1320. As such, ULFP 1320 can be reinforced with thicker beam elements or with beam element with larger load-carrying capacity by using a combination of stronger material (e.g. titanium) and different cross-sectional profile (e.g., I-shaped cross-section). Alternatively, one or more triangular sub-lattice structures of ULFP 1320, where the fixtures are coupled thereto, can have a relatively heavier duty cross-sectional thickness profile. Triangular sub-lattice structures with fixtures affixed thereto can be referred to as supporting sub-lattice structures 322. In some embodiments, the load-carrying capacity (e.g., constituent material, cross-sectional thickness, and/or cross-sectional shape) of non-supporting sub-lattice structures 324 can be less than that of supporting sub-lattice structures 322. For example, the bottom half portion of module frame 105 can a thinner cross-section than ULFP 1320. Additionally, one or more supporting sub-lattice structures 322 of module frame 105 can be further reinforced with tie rods, which can be affixed to each end of one or more lattice beams 305 or to one or more hubs 310 of the supporting sub-lattice structure 322.

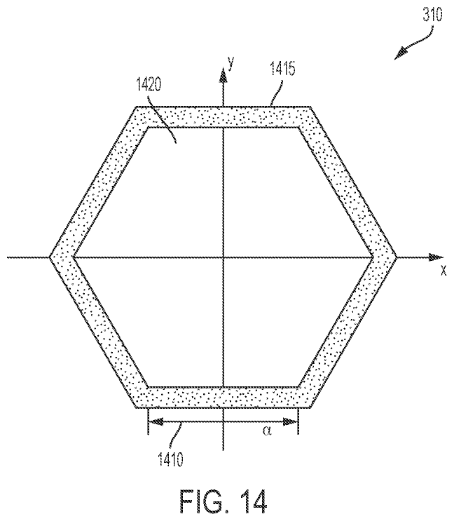

FIG. 14 illustrates hub 310 in accordance with some embodiments of the disclosure. Hub 310 has a hexagonal shape so that lateral forces can be distributed along lattice beams 305 coupled to hub 310. The length 1410 of each side face of hub 310 can, in certain examples, be in a range of 70 mm to 200 mm. In some examples, hub 310 can have a thickness range of 1 mm to 10 mm.

Each corner 1415 of hub 310 can also be rounded to avoid stress points from developing. As shown elsewhere herein, hub 310 can have six beam elements 305, with one attached to each side of hub 310. Hub 310 can have a wholly or partially hollow or open center 1420, which enables various items to be installed therein or attached thereto. For example, a power socket can be installed in center 1420, or a tie rod can be attached to hub 310 at center 1420. Center 1420 can also provide a convenient location for attaching interior cabin panels and other cabin fixtures such as hatrack, PSC, or support components for securing beds and furniture, for example. Hub 310 can have other rounded or polygonal shapes such as a circle, ellipse, square, pentagon, or an octagon, for example, while remaining within the scope of this disclosure.

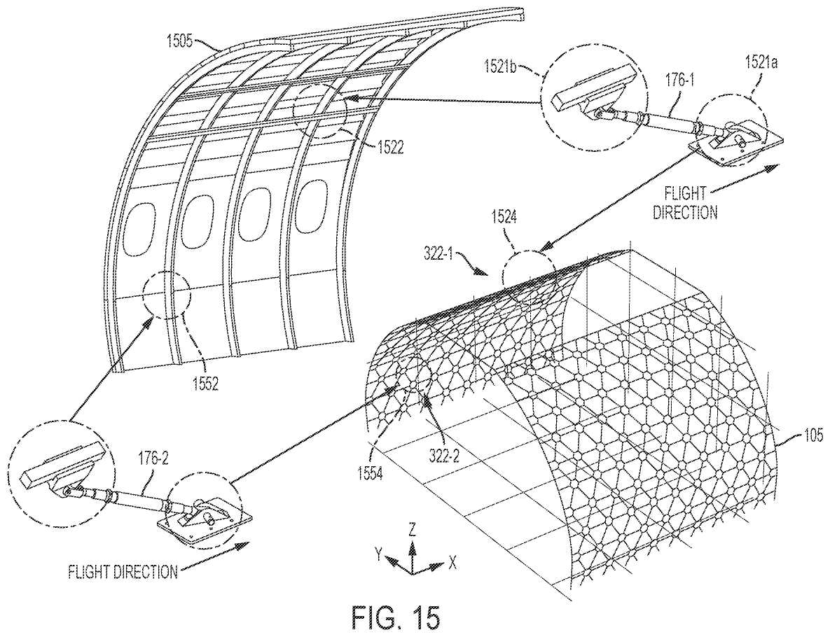

FIG. 15 illustrates a module frame 105 and a portion of an aircraft fuselage 1505 being coupled to each other with tie rods 176-1 and 176-2 in accordance with some embodiments of the disclosure. In this figure the positive x-direction (flight direction) is noted. Module frame 105 includes supporting sub-lattice structures 322-1 and 322-2, each of which has one or more fixtures (not shown) attached thereto. Supporting sub-lattice structure 322-1 can be coupled to fuselage 1505 with tie rod 176-1 at connection points 1522 and 1524. Similarly, supporting sub-lattice structure 322-2 can be coupled to fuselage 1505 with tie rod 176-2 at attachment points 1552 and 1554. Although not shown, supporting sub-lattice structures 322-1 or 322-2 can be coupled to fuselage 1505 by two or more tie rods 176 to provide additional axial support at various angles.

Each tie rod 176 can extend wholly or substantially in the y-direction, x-direction, or z-direction. In other embodiments, each tie rod 176 can extend in combination of x, y, and/or z directions. Each tie rod 176 can be coupled to fuselage 1505 using any combination of a B-bracket, C-bracket, and D-bracket. Each of the bracket type can be a y-direction or x-direction bracket and can have a quick release pin component. Each bracket can be a ball joint type bracket to allow a tie rod to be swivel in various directions. Each bracket can be adjusted to allow the tie rod to pivots, elevate, or otherwise travel in the x, y, or z direction to provide flexibility when connecting the tie rod body to the bracket or when connecting the brackets to the fuselage. Each of the brackets can be coupled to fuselage 1505 and supporting sub-lattice structure 322 with high strength aviation shear bolts and nuts, aviation grade structural adhesive, weldments, or a combination thereof.

Each module frame 105 can be rigidly secured to fuselage 1505 with tie rods 176 positioned at various locations on lattice structure 174 such as on various side locations of lattice structure 174 (e.g., 1524, 1554), along ceiling frames 172a, 172b, 183a and 183b, along side frames 171a, 171b, 173a, and 173b, and along corner locations where side frames and ceiling frames are joined. Each ceiling frame can include two or more tie rods 176 to rigidly secure each ceiling frame to the top portion of fuselage 1505. Each side frame can also include two or more tie rods 176 to rigidly secure each side frame to the side of fuselage 1505. Each module frame 105 can be flexibly coupled to one or more adjacent module frames using flexible connection mechanisms to provide some movements between each module as fuselage 1505 can flex under in flight stresses. Each module frame 105 can have one or more flexible inter-module seals designed to mate with the perimeter of an adjacent module frame or with a corresponding inter-module seal on the adjacent module frame to provide a flexible, yet tight, abutment between two module frames. The inter-module seal can be made of rubber or other type of flexible and durable material.

As shown here, tie rod 176-1 includes connection ends 1521a and 1521b. Connection end 1521a can be coupled to connection point 1524 of supporting sub-lattice structure 322-1. Connection point 1524 can be at a hub 310 of supporting sub-lattice structure 322-1 that is closest to connection point 1522 of fuselage 1505. Connection point 1522 can be located at one of the frame ribs of fuselage 1505 and can be further reinforced with a longitudinal stringer that connects adjacent frame ribs together.

Each of the supporting sub-lattice structures 322 can be reinforced with multiple tie rods 176 oriented at different angles. In this way, each supporting sub-lattice structure 322 can be axially supported at various angles. In some embodiments, the opposite end of each tie rod 176 (e.g., the end not coupled to fuselage 1505) can be coupled to a lattice beam element 305 to provide axial strength to the beam element.

Ceiling frames 183a and 183b can be securely coupled to the top of the aircraft's fuselage using multiple tie rods 176 affixed along the length of frames 183a and 183b. Ceiling frames 172a and 172b can also be coupled to the fuselage with multiple tie rods 176. One or more of the tie rods 176 can be tie rod cylinders or hydraulic tie rods. In this way, the axial loading and/or the axial length of the tie rod can be changed as desired.

It should be noted that each of the module frames 105 and components thereof described and/or shown herein (e.g., FIGS. 1G, 1H, 3, 4A, 4B, 5A, 5B, and 6-15) can be implemented with one or more features of each other module frame. In other words, the features described in each embodiment are freely combinable with the features described in each and every other embodiment, unless the context or logic dictates otherwise. A module frame 105 implemented with features from the various embodiments described herein will preferably be done so while meeting the required maximum payload crash loading conditions. As known by those of skill in the art, these requirements will vary depending on the regulation and administrative agency.

### Example Embodiments of Module Floors & Module-to-Fuselage Locking Mechanisms

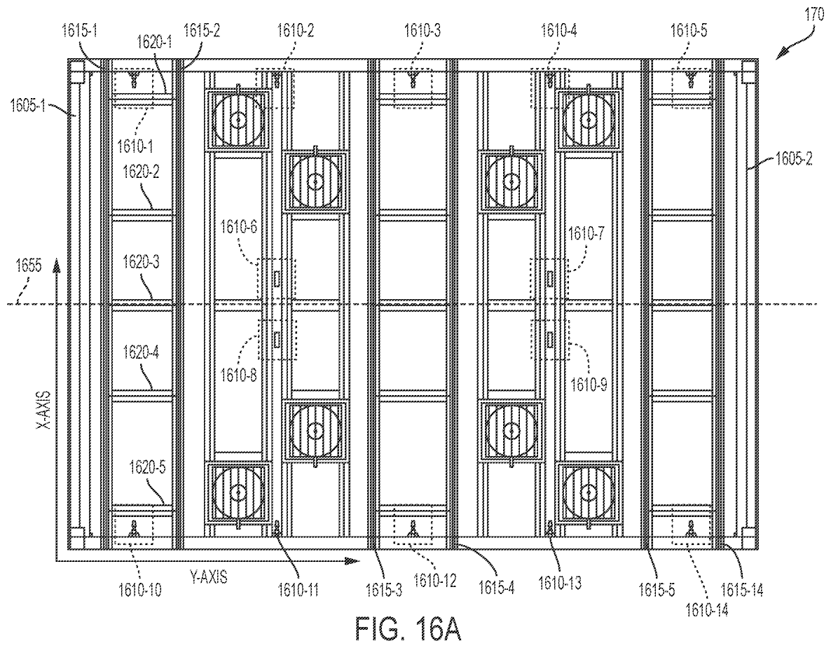

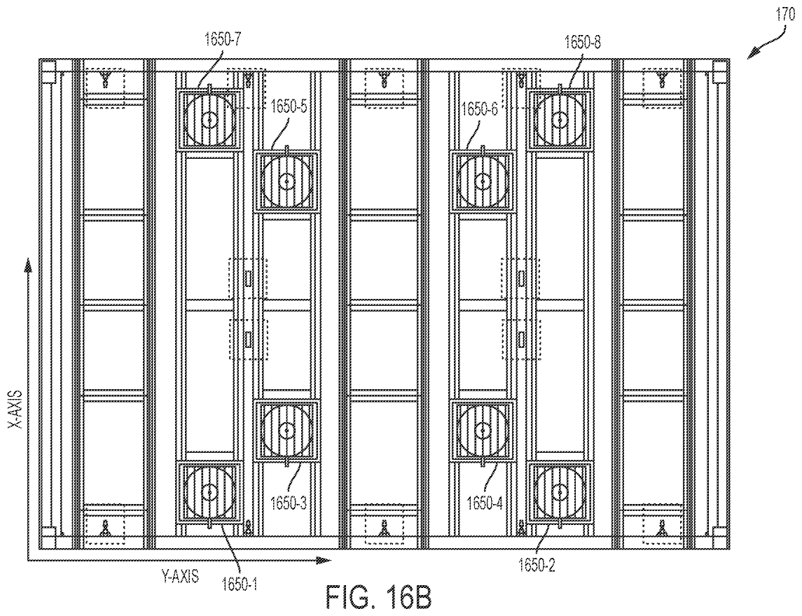

FIGS. 16A-B are bottom up views illustrating an example embodiment of the underside of a floor 170 of a module frame 105. FIGS. 16A-B depict the same module floor but with different components called out with reference numerals for ease of illustration. Module floor 170 can include any number of one or more x-direction stiffener beams 1605 (FIG. 16A), one or more module to fuselage attachment bracket locations 1610 (FIG. 16A), one or more module seat tracks 1615 (FIG. 16A), one or more y-direction stiffener beams 1620 (FIG. 16A), and/or one or more module lifters 1650 (FIG. 16B).

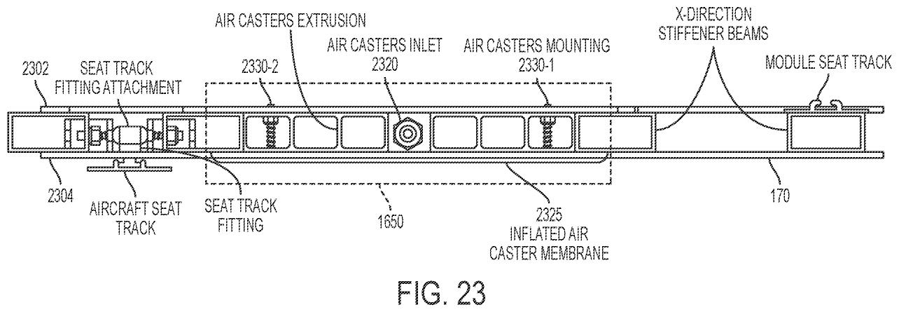

Module floor 170 can include one or more plates 2302 and 2304 with stiffener beams 1605 positioned underneath the upper most plate or sandwiched between plates 2302 and 2304 (where there are multiple plates, see FIG. 23). Optional lower plate 2304 is shown in FIGS. 16A-B and upper plate 2302 is obscured. In some embodiments, stiffener beams 1605 can be located along the port and starboard side of floor 170. An additional stiffener beam 1605 can be affixed where desired, such as along the center-longitudinal axis of plates 2302 and 2304, and/or adjacent to each seat track 1615. In some embodiments, the thickness of the module floor 170 can be in the range of 25 mm to 80 mm, although module floor 170 can have other thicknesses.

In some embodiments, module floor 170 includes one or more y-direction stiffener beams 1620 coupled between adjacent seat tracks 1615. In the embodiment shown in FIGS. 16A-B, module floor 170 has three pairs of seat tracks 1615 (1615-1 and 1615-2, 1615-3 and 1615-4, and 1615-5 and 1615-6) and five y-direction stiffener beams 1620 between each pair of seat tracks 1615 (see, e.g., beams 1620-1 through 1620-5 between seat tracks 1615-1 and 1615-2). The number of x-direction stiffener beams 1605, seat tracks 1615, and y-direction stiffener beams 1620 can be adjusted appropriately based on the size of aircraft 102 as the overall size and inertial loading requirements of module floor 170 can be changed. Although not shown, y-direction stiffener beams 1620 can also be positioned along the entire aft and forward edges of module floor 170. Each of the x-direction and y-direction stiffener beams can be directly coupled to module floor 170 using a combination of welding, adhesive, and mechanical fasteners such as nuts and bolts, or the like.

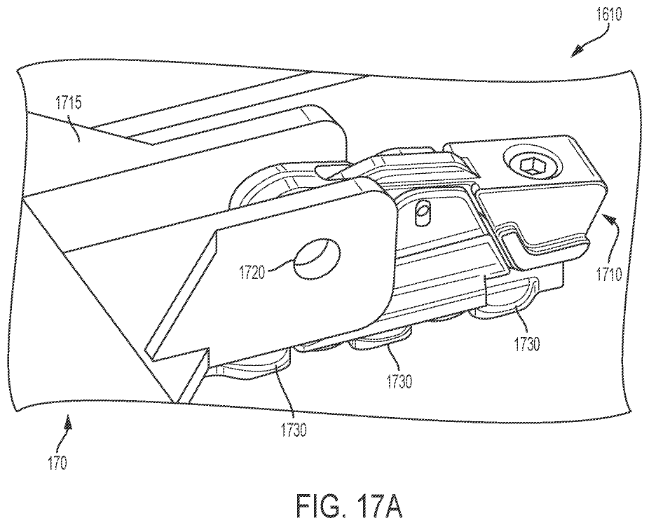

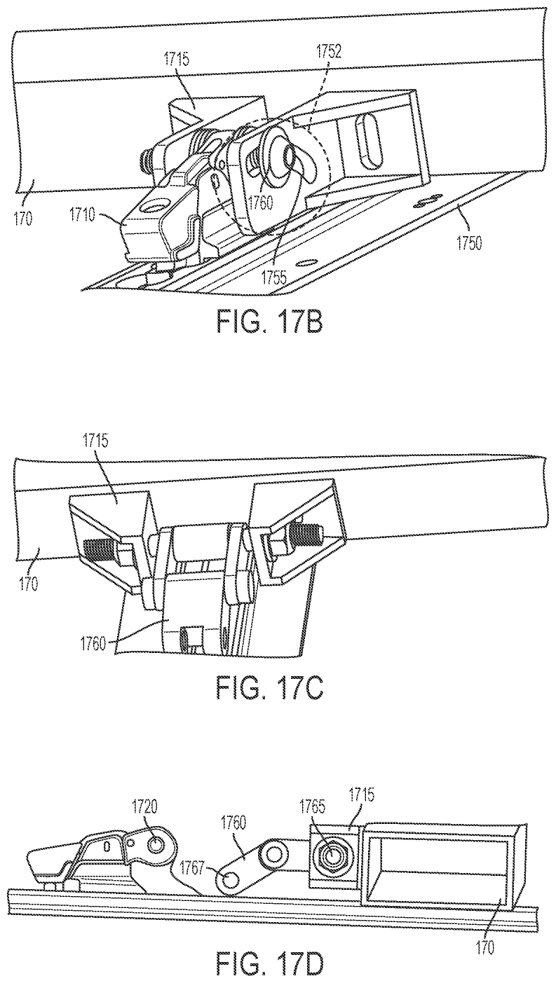

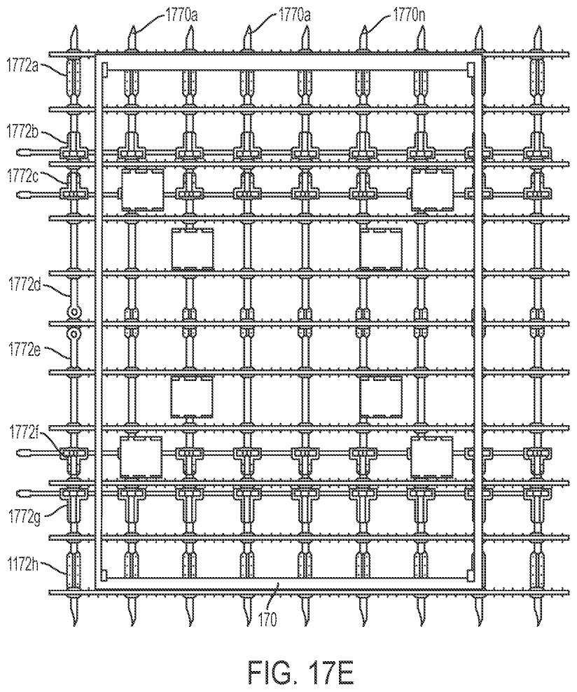

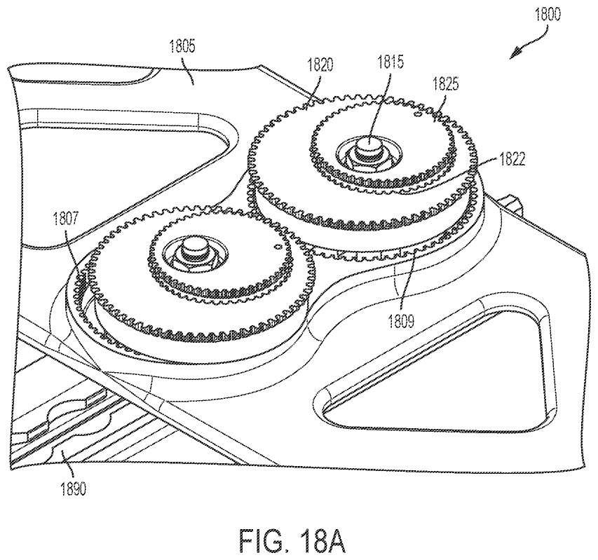

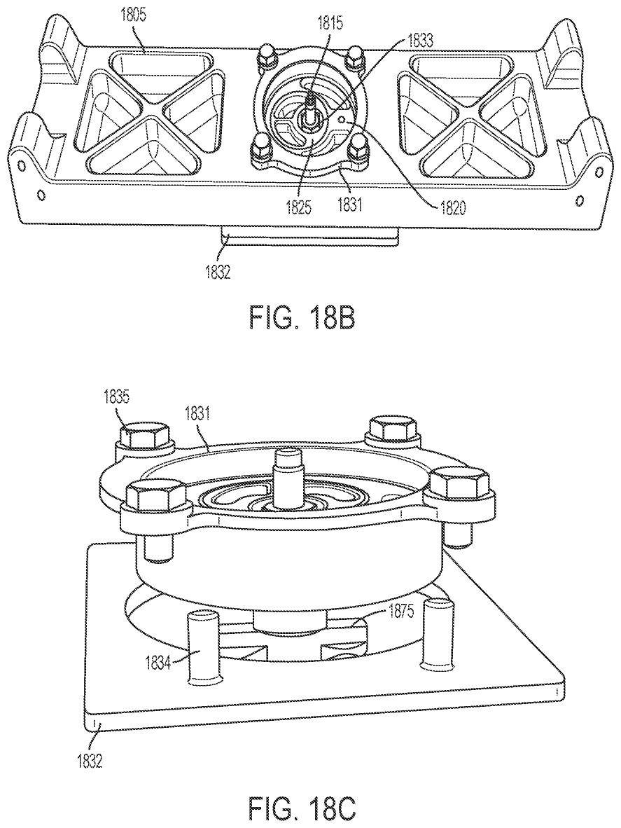

Module floor 170 can have one or more attachment locations 1610. Each attachment location 1610 can have a module-to-fuselage attachment bracket that can include linkages and brackets (see FIGS. 17C-D) or a gear-based attachment assembly (see FIG. 18). In the embodiment depicted in FIG. 16A, module floor 170 has five attachment locations 1610 (1610-1, 1610-2, 1610-3, 1610-4, and 1610-5) along the forward edge (e.g., at top) of module floor 170. Module floor 170 can have three attachment locations 1610 (1610-10, 1610-12, 1610-14) along the aft edge (e.g., at bottom), and four attachment locations 1610 (1610-7, 1610-8, 1610-9) in the central region. In one embodiment, module floor 170 can have additional attachment locations 1610 along the aft edge such as attachment locations 1610-11 and 1610-13. Module floor 170 can also have a plurality of attachment brackets situated on and/or near a central lateral axis 1655 of module floor 170. In one embodiment, four attachment locations 1610 (1610-7, 1610-8, 1610-9), two on each side of central lateral axis 1655, are integrated into module floor 170. It should be noted that module floor 170 can have more (or less) than four attachment locations 1610 on or near the central lateral axis as the number of attachment locations 1610 can be adjusted appropriately based on the size and/or inertial loading requirements of module floor 170. In the embodiment depicted here, module floor 170 has 14 attachment locations 1610, but more (or less) than 14 attachment locations 1610 can be employed while remaining within the scope of this disclosure. The total amount of attachment locations 1610 can be adjusted based on the size and structural strength requirements of module floor 170 (and the aircraft frame payload allowable in the designated area for the module). Each of the attachments can be actuated using cam shafts, Bowden cables, or other mechanical actuators.

In some embodiments, module floor 170 includes eight module lifters 1650, four proximally located to the aft edge and four proximally located the forward edge of module floor 170. Depending on the size of module floor 170 and/or attachment-strength requirement, module floor 170 can have less than or more than eight lifters 1650. For example, module floor 170 can have five or six lifters 1650 proximally located near each of the aft and forward edges. Module floor 170 can also include one or more lifters 1650 along or proximal to its center y-axis.

Module floor 170 can include an access panel at each of the attachment locations 1610 and lifter 1650 locations. In this way, aircraft/service personnel can gain access to each of the brackets and module-to-fuselage attachment assemblies to perform service and/or attaching or de-attaching procedure to the aircraft's fuselage floor. In one embodiment, each of the brackets and module-to-fuselage attachment assemblies is coupled to an automatic-attachment device (not shown) that automatically couples each bracket and assembly to a respective attachment point on the floor of the fuselage. In this way, aircraft/service personnel can attach or detach module floor 170 from floor of the fuselage at a single control location.

FIG. 17A illustrates module-to-fuselage attachment bracket 1610 in accordance with some embodiments in the present disclosure. Attachment bracket 1610 can include a bracket component 1710 coupled to a bracket frame 1715, which is securely coupled to module floor 170 by bolts, aviation grade adhesive, weldments, or a combination thereof. Bracket component 1710 can be pivotally coupled to bracket frame 1715 at coupling point 1720. Bracket component 1710 can include a plurality of flanges 1730 on each of the port and starboard sides. Flanges 1730 are designed to drop into the seat track (1750 of FIG. 17B) located on the floor of an aircraft's fuselage when bracket component 1710 is pivoted downward toward the seat track.

FIG. 17B illustrates module-to-fuselage attachment bracket 1610 in accordance with some embodiments in the present disclosure. Here, bracket frame 1715 can include a slot 1755 in an extended portion 1752 of bracket frame 1715 to provide some flexibility of movement while installing and securing a pin 1760 to bracket component 1710. FIGS. 17C-D illustrate a linkage assembly for coupling bracket component 1710 to bracket frame 1715 in accordance with some embodiments in the present disclosure. In this embodiment, extended portion 1752 as shown in FIG. 17B is replaced with a linkage assembly 1760. Linkage assembly 1760 can be pivotably coupled to bracket frame 1715 at one end. The other end of linkage assembly 1760 is then pivoted about a pivot point 1765 to enable a hole 1767 to move up and down. This allows for easier alignment between hole 1767 and coupling point 1720 of bracket component 1710, which will be coupled together using a bolt and nut or an attachment pin similar to pin 1760.

In some embodiments, to engage bracket component 1710, the entire cabin module (e.g., cabin module 105) can be floated (using air or magnets) into position. Once the cabin module is in position, bracket component 1710 can be pivoted downward to drop flanges 1730 into the openings of the seat track on the floor of the fuselage. Next, module floor 170 can be translated by a small distance along the direction of the seat track to lock bracket component 1710 into the seat track. As previously noted, module floor 170 can include any number of one or more bracket components 1710 along the aft and/or forward edges of module floor 170. Module floor 170 can also have a plurality of bracket components situated at and/or near the center y-axis (not shown) of module floor 170. In one embodiment, four bracket components 1710, two on each side of the center y-axis, are coupled to module floor 170. More or less than 14 bracket components 1710 can be employed while remaining within the scope of this disclosure. The total amount of attachment bracket components 1710 can be adjusted based on the size and attachment strength requirement of module floor 170.

FIG. 17E illustrates a top-view of example attachment locations for coupling module floor 170 to the floor of a fuselage of an aircraft in accordance with some embodiments in the present disclosure. As shown in FIG. 17E, module floor 170 is shown as an outline as indicated by item 170. The main floor of the fuselage, which sits below module floor 170, includes a plurality of floor frames 1770a-1770n running laterally across the main floor of the fuselage. Each of the floor frames can include a plurality of attachment adapters 1772a, 1772b, 1772c, 1772d, 1772e, 1772f, 1772g, and 1772h, each of which can couple with any one of the bracket frames shown in FIGS. 17B-D. In some embodiments, each floor frame can have up to eight adapters.

In some embodiments, a double-eccentric-attachment assembly can be used instead of bracket component 1710 to couple module floor 170 to the floor of the aircraft's fuselage. The double-eccentric-attachment assembly can be geared or gearless. FIG. 18A illustrates an example embodiment of the module-to-fuselage gear-based attachment assembly 1800 in accordance with certain embodiments of the disclosure. Attachment assembly 1800 can include a mounting bracket 1805, a locking shaft 1815, an outer eccentric gear 1820, and an inner eccentric gear 1825. Attachment assembly 1800 does not include seat track 1890, which can be part of the floor of the aircraft's fuselage. Attachment assembly 1800 can be designed to engage and lock onto seat track 1890 located on the floor of the aircraft's fuselage. In other embodiments, attachment assembly 1800 can be configured to lock into other track designs of other aircraft fuselage floors. Once engaged, the one or more attachment assemblies 1800 can secure module floor 170 to the aircraft fuselage floor and prevent movement in all three dimensions.

In attachment assembly 1800, mounting bracket 1805 can be rigidly secured to module floor 170. Mounting bracket 1805 can be securely coupled to module floor 170 using one or more of aviation grade shear nuts and bolts, aviation grade adhesive, welds, or the like. Mounting bracket 1805 includes one or more of annular gears 1807 with internal cogs for receiving outer eccentric gears 1820, each of which also includes an internally-cogged annular gear 1822. Inner eccentric gear 1825 and locking shaft 1815 are pivotably attached together and are designed to orbit annular ring 1822 of eccentric gear 1820.

Mounting bracket 1805 can include one or more circular slots 1809 where each of the annular gears 1807 is formed. In some embodiments, each circular slot is gearless. In other words, the inner surface of each circular slot can be smooth, and the cogs of each annular gear are not present. In other words, each annular gear can be replaced non-geared component such as an eccentric circular component. In this embodiment, each of the outer and inner eccentric gears is also gearless (without cogs) to form outer and inner eccentric circular components (each without gears). FIG. 18B illustrates an example embodiment of a gearless attachment assembly 1850 which includes mounting bracket 1805, locking shaft 1815, gearless outer eccentric component 1820, gearless inner eccentric component 1825, a mounting housing 1831, and a bottom mounting plate 1832. Inner and outer eccentric components 1820 and 1825 can be pivotably secured to top mounting housing 1831 by a locking nut 1833. Top mounting housing 1831 can be secured to bracket frame 1805 by sandwiching bracket 1805 between housing 1831 and mounting plate 1832. Top mounting housing 1831 and bottom mounting plate 1832 can be secured to each other using pins 1834 and nuts 1835.

Both of the geared and gearless double-eccentric-attachment assemblies operate in the same manner. Both embodiments can provide flexible movements of a foot portion 1875 of locking shaft 1815 to make it easy to manipulate foot portion 1875 into the grooves of the seat track.

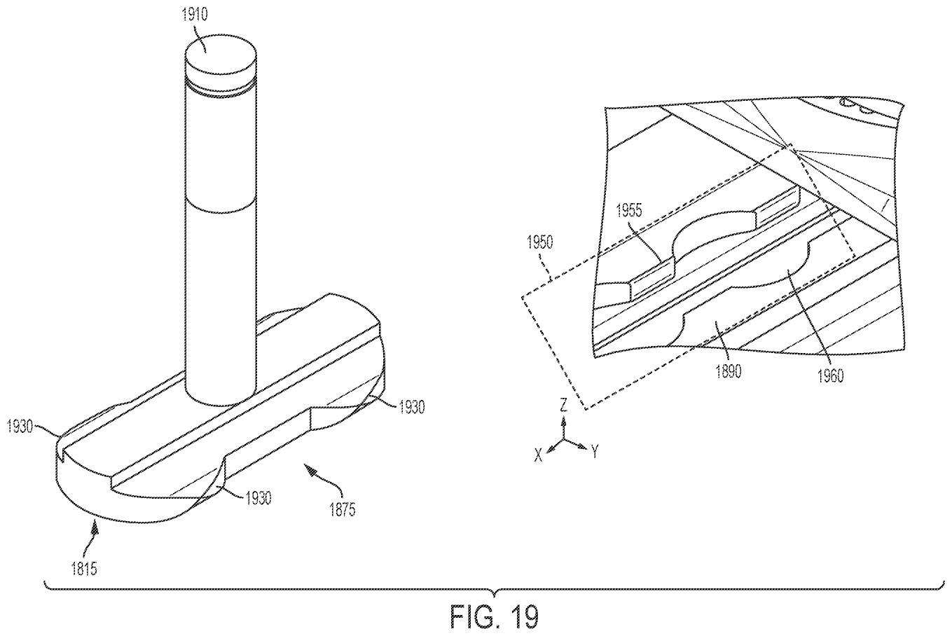

FIG. 19 further illustrates locking shaft 1815 in accordance with some embodiments of the present disclosure. Locking shaft 1815 includes a shaft portion 1910 and foot portion 1875, which generally have a rectangular shape with a plurality of flanges 1930 on each side. Foot portion 1875 can have one or more flanges 1930 on the port and/or starboard sides of foot portion 1875. In one embodiment, foot portion 1875 has a total of four flanges 1930. Foot portion 1875 is designed to drop into area 1950 of seat track 1890 as circle portion 1960 of seat track 1890 is larger than the widest part foot portion 1875.

In some embodiments, module-to-fuselage attachment location 1610 (FIG. 16A) is located within module floor 170 and can be accessed via an access panel (not shown). Attachment assembly 1800 is held in place by mounting bracket 1805, which is rigidly attached to module floor 170 at a plurality of locations to ensure a strong and secure attachment.

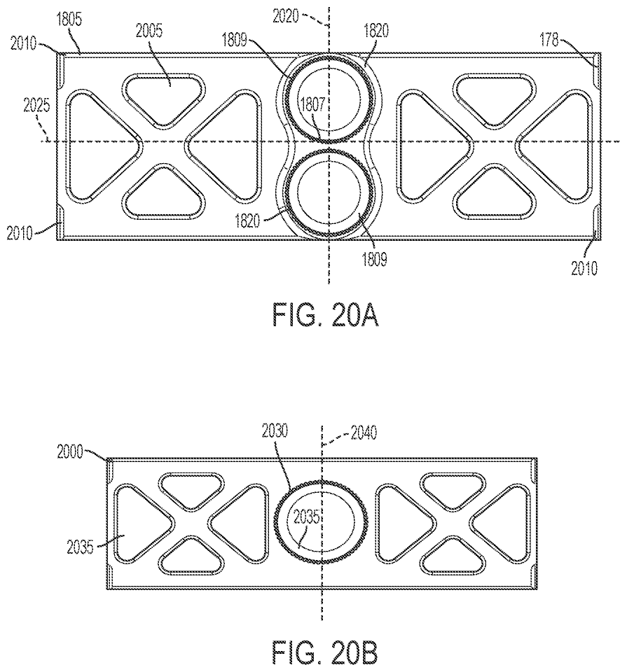

FIG. 20A illustrates mounting bracket 1805 in accordance with some embodiments of the disclosure. Mounting bracket 1805 includes two circular slots (or openings) 1809 with internal cogs 1807 to form annular gears 1820. In some embodiments, each circular slot is smooth and does not have internal cogs. The center of each slot 1809 (and gear 1820) can be disposed along the center axis 2020 of bracket 1805. Alternatively, slots 1809 and annular gears 1820 can be disposed along axis 2025. Mounting bracket 1805 also includes a plurality of slots 2005 to reduce the overall weight of bracket 1805. Mounting bracket 1805 can be securely attached to module floor 170 at one or more attachment locations 2010. As previously mentioned, mounting bracket 1805 can be securely attached to module floor 170 using aviation grade nuts and bolts, aviation grade adhesive, weldments, or a combination thereof.

FIG. 20B illustrates a mounting bracket 2000 with only a single circular slot/opening 2030. Mounting bracket 2000 can be smaller than mounting bracket 1805 as it only has one slot 2030. Additionally, mounting bracket 2000 can be appropriately sized to fit into a smaller module-to-fuselage attachment location 1610. Slot 2030 can have internal cogs to form an annular gear 2035. Alternatively, slot 2030 does not have internal cogs. Annular gear 2035 can be identical to annular gear 1820. Alternatively, the size of annular gear 2035 can be different than the size of annular gear 1820. Annular gear 2035 is also located on a center axis 2040 of mounting bracket 2000. Additionally, annular gear 2035 also includes an internally cogged annular gear 2035, which will house one or more eccentric gears as described below.

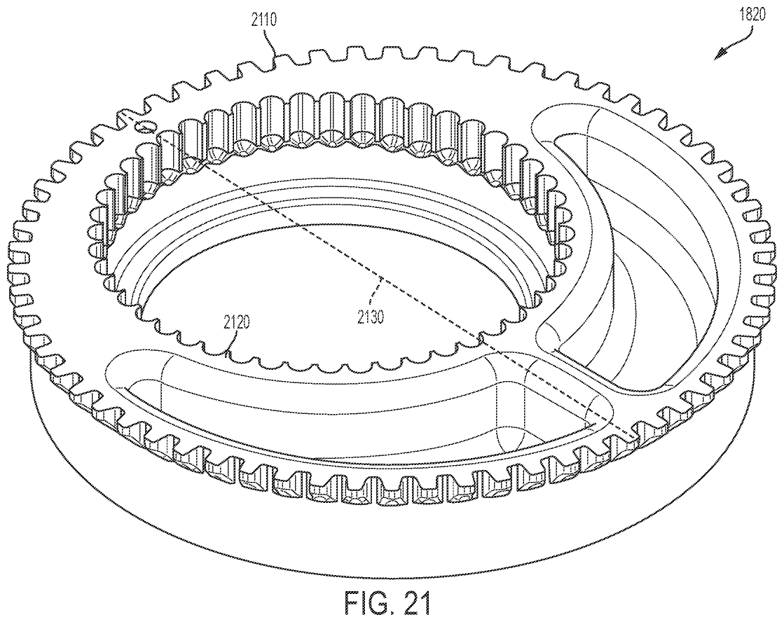

FIG. 21 illustrates outer eccentric gear 1820 in accordance with some embodiments of the present disclosure. Eccentric gear 1820 includes external cogs 2110 and an internally-cogged annular gear 2120. The axis of rotation of eccentric gear 1820 is in the middle of annular gear 2120, which is off-center from the center of mass of gear 1820. Additionally, the overall diameter 2130 can be less than the diameter of annular gear 1807 of mounting bracket 1805 or annular gear 2035 of mounting bracket 2000. In some embodiments, outer eccentric gear 1820 is formed without cogs 2110 and 2120 to form a gearless outer eccentric component.

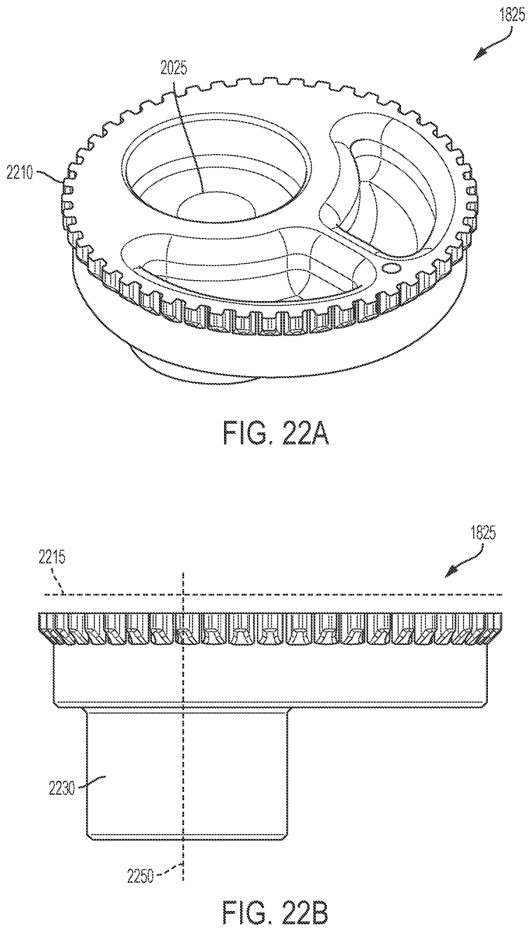

FIGS. 22A and 22B illustrate inner eccentric gear 1825 in accordance with some embodiments of the present disclosure. Inner eccentric gear 1825 includes external cogs 2210, a circular slot 2025, and a locking foot 2230. External cogs 2210 are configured to orbit and move in interlocking fashion along the internal cogs of annular gear 2120 of outer eccentric gear 1820 when rotated about axis 2250. In some embodiments, inner eccentric gear 1825 is formed without cogs 2210 to form a gearless inner eccentric component. Whether geared or gearless, inner eccentric component or gear operates the same way. Circular slot 2025 houses locking shaft 1815, which is centered along axis 2250. In some embodiments, as gear 1825 is rotated about shaft 1815, locking foot 2230 becomes aligned with a circular slot 1960 of seat track 1890. The rotations of outer and inner eccentric gears 1820 and 1825 (or components, no gears) enable locking foot 1920 to have flexible movements about the x-y plane. This can allow for locking foot portion 1875 to be easily manipulated to create alignment with the groove of the seat track. Once aligned, locking foot 2230 falls into circular slot 1960 and thereby prevents locking shaft 1815 to move along the longitudinal axis of seat track 1890.

For ease of description, locking shaft 1815, outer eccentric gear 1820, and inner eccentric gear 1825 can be referred to as a group as a locking-gear assembly. During the cabin module loading and attaching operation, an entire cabin module (including module floor 170) is moved (or floated) into an aircraft's fuselage (e.g., fuselage 112) and into position for attachment. Once module floor 170 is at the proper position for attachment, the locking-gear assembly (i.e., locking shaft 1815, gears 1820 and 1825) is lowered into annular ring 1807 of bracket 1805 or 2000. The lowering of the locking-gear assembly also causes locking shaft 1815 to be lowered into seat track 1890. It should be noted that the locking-gear assembly can be translated by a small distance along the x-direction (longitudinal axis of the fuselage) within annular ring 1807 if both eccentric gears 1820 and 1825 are in the unlocked or default position.

Eccentric gears 1820 and 1825 can be rotated to cause the locking foot 1875 to move in various directions about the x-y plane. Once the right movements are created, locking foot 1920 falls into the grooves of seat track 1890. The rotations of eccentric gears 1820 and 1825 (or their gearless components) also cause locking shaft 1815 to translate within the groove of seat track 1890 and become z-direction-locked in seat track 1890. In other words, when locking shaft 1815 is translated in the x-direction (longitudinal direction of seat track 1890), flanges 1930 move and rest below overhang or lip portion 1955. Because the distance from the port side of flange 1930 to the starboard side of flange 1930 is larger than the gap of narrow portion 1955, locking shaft 1815 is locked in the z-direction due to interference with narrow portion 1955. Locking shaft 1815 is also locked in the y-direction because of interference with the internal walls of seat track 1890.

Once locking foot 1875 of locking shaft 1815 is locked in they and z directions within the seat track and locking foot 2230 lowered into opening 1960, the entire attachment assembly is tightly secured from moving by tightening bolt 1833, which tightly locks eccentric components 1820 and 1825 onto housing 1831. With both components 1820 and 1825 are locked down and unable to move, the module-to-fuselage locking procedure is completed since movement in all directions (x, y, or z) is no longer permitted by the locking-gear assembly. In some embodiments, each of the eccentric components can include see-through openings (not shown) that allow an operator to see through both components and determine whether locking foot portion 1875 and locking foot 2230 are appropriately engaged with seat track 1890.

### Example Embodiments of Cabin Module Lifter Systems

Traditionally, heavy cargo is moved into a cargo bay of an aircraft using rollers. Additionally, the use of air nozzles in the floor of the aircraft has been proposed (see, e.g., European Patent Application Nos. 2,815,970 and 2,815,982). The roller-based systems are disadvantageous due to friction, wear and tear, weighty, and typically require the manual application of force to move the cargo. Floor-installed air nozzle based cargo loading systems exhaust air at a high flow rate- out of the floor and at a direction perpendicular to the floor. The floor-installed air nozzles are distributed across the floor of the cargo bay. During a cargo loading or unloading operation, air is introduced into the system and out of the exhaust nozzles (or openings) embedded in the cargo floor to support and lift the weight of the cargo being loaded. This system can be suited for dedicated cargo aircrafts but can be expensive as it requires numerous air nozzles pre-installed in the floor of the fuselage. Further, the system is inherently inefficient as it is not customizable for the size of the cargo and can be prone to oversupply air as the cargo moves through. The air exhaust can be difficult to control because it is not in a closed and controlled system.

FIG. 23 illustrates cabin module lifter 1650 in accordance with some embodiments of the disclosure. Module lifter 1650 is integrated into module floor 170, which is directly coupled to module frame 105 by one or more of aviation grade shear bolts and nuts, welds, adhesives, or the like. As shown in FIG. 23, module lifter 1650 can be securely coupled to module floor at multiple coupling or mounting locations 2330-1 and 2330-2. Module lifter 1650 can be fully embedded within module floor 170 such that no portion or component of module lifter 1650 is extended beyond the upper or lower floor plate of module floor 170. In some embodiments, module lifter 1650 can be an air caster system.

In some embodiments, where module floor 170 only has an upper plate and without a floor plate, each air caster can be coupled to the upper plate of module floor 170. During operation of the air caster, the air caster can push on the upper plate and lift module floor 170 by the upper plate only. In this embodiment, the floor to aircraft attachments are fixed to the beams of module floor 170 by use of brackets. In some embodiments, the upper plate can have more beams coupled to its underside. In this way, the stiffness of module floor 170 can be increased.

Module lifter 1650 can include one or more air inlets 2320 and a plurality of inflatable membranes 2325. Each air inlet 2320 can be accessed via an access panel located on the floor of module floor 170. Alternatively, each air inlet 2320 can be oriented perpendicular and can be flushed to module floor 170. In this way, an external coupling from an air source can be directly coupled to inlet 2320 without having to open an access panel.

The air pressure and/or rate of flow within each inflatable membrane 2325 can be independently controlled. In this way, load imbalances on the cabin module can be corrected by adjusting the air pressure and/or rate of flow at each of the individual module lifters 1650. For example, if a cabin module is heavier on the port side than the starboard side, then inflatable membranes 2325 of module lifters 1650 located on the port side can be adjusted to have greater air pressure than inflatable membranes 2325 of module lifters 1650 located on the starboard side. In some embodiments, a single air inlet 2320 can provide air to all inflatable membranes 2325 of module lifters 1650. In this embodiment, each membrane 2325 can have an electronically controlled valve or air pressure manifold (not shown) to adjust the air received from inlet 2320. In this way, the electronically controlled air pressure manifold can control the air pressure of each individual membrane 2325. Alternatively, each inflatable membrane 2325 can be serviced by its own air inlet 2320.

In some embodiments, each of the lifters 1650 of FIG. 16B is identical to module lifter 1650. Depending on the size of module floor 170 and/or attachment-strength requirement, module floor 170 can include any number of one or more lifters 1650. In the embodiment depicting in FIG. 16B, module floor 170 includes eight module lifters 1650. Four module lifters 1650 can be proximally located at the aft edge, with two lifters being closer to the center y-axis of module floor 170. Additionally, four more module lifters 1650 can be proximally located at the forward edge of module floor 170, two of which are closer to the center y-axis of module floor 170. In other example embodiments, module floor 170 can have five or six module lifters 1650 along each of the aft and forward edges. Module floor 170 can also include three or more module lifters 1650 along or proximal to its center y-axis.

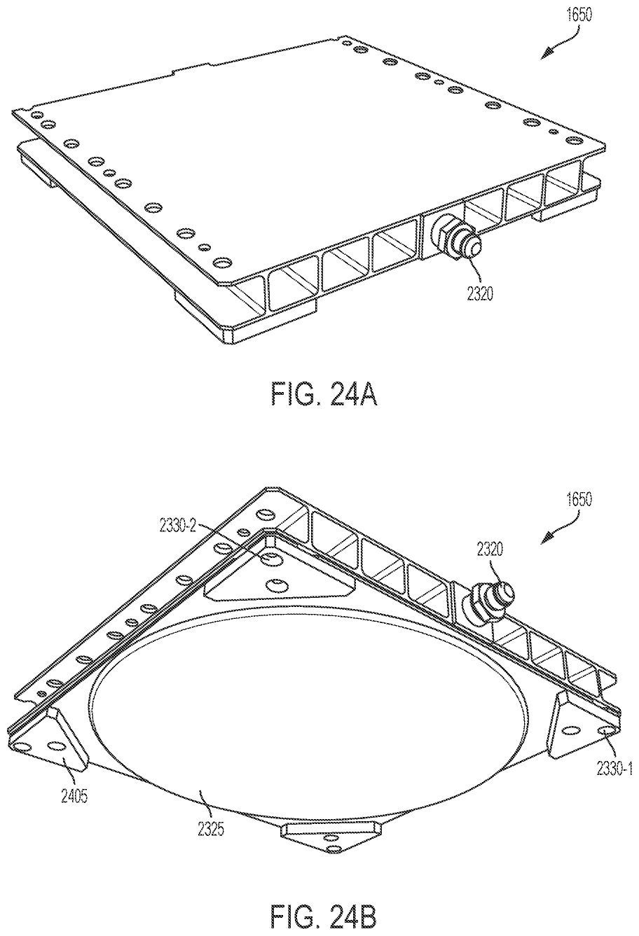

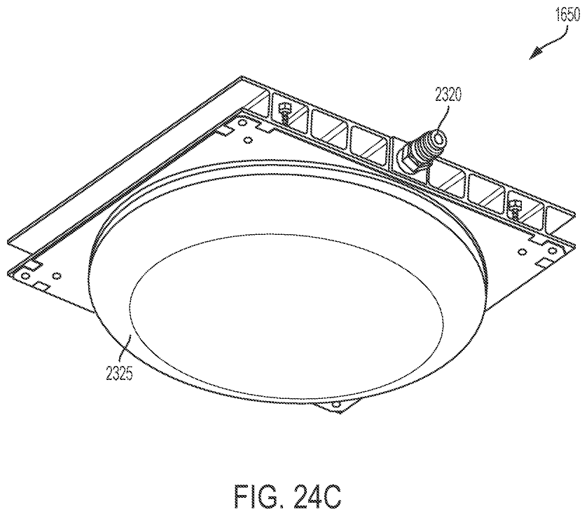

FIG. 24A is a perspective view showing the top of module lifter 1650, and FIG. 24B is a perspective view showing the bottom of module lifter 1650 in an uninflated state. In an uninflated state, the thickness of membrane 2325 can be less than the thickness of a base extension or mounting pad 2405 on the bottom side of module lifter 1650. In this way, the bottom surface of membrane 2325 is protected by pad 2405 or by an optional lower plate 2304 of module floor 170.

FIG. 24C is a perspective view of the bottom of module lifter 1650 in an inflated state. Once inflated, membrane 2325 can extend perpendicularly to module floor 170 and can raise module floor 170 over a thin film of air. (Mounting pads 2405 are not shown.) Each inflatable membrane 2325 can be a semi-closed system, meaning air exhaust is allowed through holes or openings (not shown) located at the bottom of each inflatable membrane 2325. However, the air exhaust can be controlled via maintaining a proper pressure within inflatable membrane 2325. With proper air pressure, module lifter 1650 can lift module 104 such that it is spaced apart from and suspended over the floor (e.g., up to 55 mm or greater) on a thin film of air under each inflatable membrane 2325.

In an exemplary cabin module loading procedure, a cabin module (e.g., module 104) is loaded on a module carrier 160 that typically has rollers on its surface. These rollers could potentially damage inflatable membrane 2325 as the cabin module is pushed into the aircraft's fuselage/cargo bay. At the very least, these rollers will increase the wear and tear of inflatable membrane 2325, if not damaging them partially or completely. Accordingly, in some embodiments, in an uninflated state, membrane 2325 is made to fully retract within module floor 170. In other words, membrane 2325, when not inflated, would naturally retract itself such that the bottom most surface of membrane 2325 is above the bottom most surface of module floor 170. In this embodiment, in an inflated state, membrane 2325 would inflate and extend beyond the bottom most part of module floor 170 in order to provide a thin layer of air to the cargo bay or fuselage's floor.

As shown in FIG. 16B, module lifter 1650 can be located at various locations on the underside of module floor 170. The locations module lifter 1650 are chosen to avoid gaps on the floor of the fuselage, such as gaps created by tracks or gaps on the floor. The lateral or y location of module lifters 1650 can be selected to run between longitudinal tracks (e.g., seat track) on aircraft's 102 floor. The longitudinal or x location of module lifters 1650 can be selected such that when one lifter 1650 encounters a gap (e.g., gap between floor panels) another nearby lifter 1650 can compensate for any air leakage caused by the gap. In some embodiments, each module lifter 1650 includes an air pressure sensor and an air-intake control. When a module lifter 1650 encounters a gap, the air pressure sensor will indicate a drop in the air pressure. Once an air pressure drop is detected on one of the lifters 1650, the air-intake control can shut off air flow to the affected lifter and divert the air to one or more adjacent module lifters 1650 to compensate for the loss of the affected lifter.

In some embodiments, a spring-biased, self-closing door panel (not shown) can be affixed adjacent to each module lifter 1650 at locations 1650 (see FIG. 16). Without any air pressure, the self-closing door panel is spring biased to slide over membrane 2325 and enclosed within a compartment within module floor 170. The self-closing door panel can have an air valve to receive a small amount of air pressure to actuate the door to an open position once air pressure is present. In this way, when module lifter 1650 is receiving air, the air pressure can overcome the force of the spring (that kept the door panel closed) to open the door panel and expose membrane 2325. In some embodiments, the self-closing door can be slidably coupled adjacent to each of the module lifters 1650 in module floor 170.

In some embodiments, each of the inflatable membranes 2325 can be made of a flexible air bladder with a plurality of holes near the edge of the bladder. Alternatively, the air bladder can have a single hole at the center of the bladder. In some embodiments, inflatable membrane 2325 is a solid structure with a plurality of small holes distributed throughout the surface of the structure (e.g., like an upside-down air hockey table). In this embodiment, the solid structure can include a soft and conformable material along the perimeter of the structure. In this way, the conformable material can closely hug the fuselage's floor to create a semi-closed environment where a thin of air film can develop.

In some embodiments, module lifter 1650 can be a magnetic lifting system which can include electromagnetic coils embedded at various locations within module floor 170. The electromagnetic coils can be used in place of or in addition to inflatable membrane 2325. Electromagnetic coils can be powered to generate magnetic fields that repel the magnetic fields of permanent magnets installed in the floor of an aircraft's fuselage. In this way, the cabin module is lifted above the fuselage's floor. Alternatively, the magnetic system can be reversed where permanent magnets are installed within module floor 170 and electromagnetic coils are installed within the floor of an aircraft's fuselage. In still other embodiments, both the fuselage floor and the module floor 170 can utilize electromagnets.

During the loading procedure of cabin module 104, there is a typically a gap between module carrier 160 and the floor of the aircraft fuselage. The gap prevents module lifters 1650 to operate properly as air would escape through the gap. To rectify this problem, module floor 170 can include a retractable apron that covers the gap and enables module lifters 1650 to lift module 104 over the gap and on the floor of the fuselage.

In many instances entities are described herein as being coupled to other entities. It should be understood that the terms “coupled” and “connected” (or any of their forms) are used interchangeably herein and, in both cases, are generic to the direct coupling of two entities (without any non-negligible intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

As used herein and in the appended claims, the singular forms “a,” “an,” and “the” include plural referents unless the context clearly dictates otherwise.

The examples and embodiments provided herein are provided for illustrative purposes and are not intended to limit the application or claims provided herein. It will be understood that the specific embodiments disclosed herein and the systems, components, methods, modules, aircraft, etc. described herein need not take the specific form described, but can instead be applied in various different or additional manners consistent with the present disclosure and claims. It will further be understood that the present disclosure need not take the specific form explicitly described herein, and the present disclosure is intended to include changes variations thereof, consistent with the appended claims and the present disclosure, for example, to optimize the subject matter described herein. The disclosed subject matter is not limited to any single or specific embodiment described herein, but rather should be construed in breadth and scope in accordance with the appended claims.

1. A transport system for a modular cabin structure for a reconfigurable
fuselage of an aircraft, the transport system comprising:
a module floor;
a plurality of non-contact lifters embedded within the module floor configured to lift the module floor above a floor of the fuselage without making physical contact with the main floor.

2. The transport system of claim 1, further comprises a frame structure for a cabin of an aircraft coupled to the module floor.

3. The transport system of claim 1, wherein the plurality of non-contact lifters comprise a plurality of air casters, each air caster comprising an inflatable pad configured to lift the module floor above the floor of the fuselage.

4. The transport system of claim 3, wherein each air caster comprises a valve to control air pressure inside the inflatable pad.

5. (canceled)

6. The transport system of claim 3, wherein the inflatable pad comprises an air bladder having a plurality of holes on an underside of the air bladder.

7-9. (canceled)

10. The transport system of claim 3, wherein the inflatable pad is configured to retract completely inside the module floor when not inflated.

11. (canceled)

12. The transport system of claim 3, further comprising an actuatable door coupled to the module floor and adjacent to the inflatable pad, wherein the actuatable door is configured to close over and cover the inflatable pad when the inflatable pad is deflated and to open when the inflatable pad is being inflated.

13-18. (canceled)

19. A modular cabin structure, comprising:
a module floor;
a frame structure coupled to the module floor; and
a lattice structure coupled to the frame structure and the module floor.

20. The modular cabin structure of claim 19, wherein the lattice structure comprises a plurality of hubs, wherein each hub is coupled to adjacent hubs by a first plurality of lattice beam elements to form a plurality of sub-lattice structures.

21. The modular cabin structure of claim 19, wherein a first beam element and a second beam element of the plurality of beam elements each have a different thickness profile.

22. The modular cabin structure of claim 19, wherein the plurality of hubs are each hexagonally-shaped structures.

23. The modular cabin structure of claim 19, wherein the plurality of hubs are each circular-shaped structures.

24. The modular cabin structure of claim 19, wherein the lattice structure comprises a plurality of lattice frame members, and wherein a thickness of each lattice frame member increases from a first end to a second end of the lattice frame member.

25. (canceled)

26. The modular cabin structure of claim 20, wherein the plurality of sub-lattice structures comprises a plurality of chained-lattice frame members running parallel with each other from the module floor to a ceiling member of the frame structure, wherein each of the chained-lattice frame members has a thickness that increases from a first end to a second end of the chained-lattice frame member, wherein each chained-lattice frame member comprises at least two lattice beam elements and a hub portion.

27-46. (canceled)

47. A module floor attachment system for locking a module floor to a main floor of an aircraft fuselage, the locking system comprising:
an attachment assembly coupled to a module floor, wherein upon rotation, the attachment assembly is configured to secure the module floor from moving in any direction.

48. The module floor attachment system of claim 47, wherein the attachment assembly comprises:
an attachment bracket directly coupled to the module floor, the attachment bracket comprising a first annular gear;
a locking foot configured to mate to a track on the main floor of the aircraft fuselage;
an inner eccentric gear rotatably coupled to the locking foot; and
an outer eccentric gear having a second annular gear, the inner eccentric gear configured travel about the second annular gear, wherein upon rotation of the inner and outer eccentric gears, the locking foot is configured to lock into position.

49. The module floor attachment system of claim 48, wherein the locking foot is rotatably coupled to an off-center axis of the inner eccentric gear, and wherein when the locking foot is locked it cannot be moved in any direction.

50. The module floor attachment system of claim 48, wherein the first annular gear is off center from a center axis of the outer eccentric gear.

51. The module floor attachment system of claim 50, wherein the first annular gear has inner cogs.

52. The module floor attachment system of claim 51, wherein the inner eccentric gear has cogs along an outer perimeter, wherein the cogs are configured to mate the inner cogs of the first annular gear.

53-67. (canceled)
